(19) United States
(12) Patent Application Publication
(10) Pub. No.: US 2026/0323200 A1
(43) Pub. Date: Oct. 15, 2026

(54) HEADSET CONTROL METHOD AND HEADSET

(71) Applicant: HUAWEI TECHNOLOGIES CO., LTD., Shenzhen (CN)

(72) Inventors: Ting Li, Toronto (CA); Yuhao Zeng, Shenzhen (CN); Chenhe Li, Toronto (CA); Qiang Xu, Toronto (CA); Haifeng Yu, Dongguan (CN); Xianchun Zhang, Dongguan (CN)

(73) Assignee: HUAWEI TECHNOLOGIES CO., LTD., Shenzhen (CN)

(21) Appl. No.: 19/701,580

(22) Filed: Jun. 8, 2026

Related U.S. Application Data
(63) Continuation of application No. PCT/CN2024/137434, filed on Dec. 6, 2024.

(30) Foreign Application Priority Data
Dec. 8, 2023 (CN) 202311692439.0
Mar. 6, 2024 (CN) 202410268442.8

(51) Int. Cl. H04R 1/10

(52) U.S. Cl. CPC H04R 1/1041; H04R 1/1008; H04R 1/1016; H04R 2420/07; H04R 2430/01

(57) ABSTRACT

A headset control method and a headset are provided. In the method, a first push operation of applying action force to the headset is detected in a first direction or a second direction, and a volume adjustment function is started, where the first direction corresponds to a volume increase function and the second direction corresponds to a volume decrease. Upon detection of duration of the action force of the first push operation is greater than or equal to first preset duration, a volume level of the headset is adjusted.

### CROSS-REFERENCE TO RELATED APPLICATIONS

This is a continuation of International Application No. PCT/CN2024/137434 filed on Dec. 6, 2024, which claims priorities to Chinese Patent Application No. 202311692439.0 filed on Dec. 8, 2023 and Chinese Patent Application No. 202410268442.8 filed on Mar. 6, 2024. All of the aforementioned patent applications are hereby incorporated by reference in their entireties.

### TECHNICAL FIELD

Disclosed embodiments relate to the field of headset technologies, and in particular, to a headset control method and a headset.

### BACKGROUND

To meet requirements of a user for comfortable wearing, ear health, hearing health, and the like, there are increasingly rich types of headsets. For example, a wireless headset includes a true wireless stereo (TWS) headset, an open wearable stereo (OWS) headset, and the like. A device form of the TWS headset is different from a device form of the OWS headset. The TWS headset uses an in-ear structure or a semi-in-ear structure. The OWS headset uses a non-in-ear structure, and has products in different forms around a periphery of an ear, an auricle, and an inner ear.

Because the OWS headset has a small quantity of interaction contacts, the OWS headset can perform only simple interaction tasks such as making or answering a call and playing music. For example, the OWS headset supports a tapping operation, and performs interaction tasks such as making or answering a call and playing music by tapping the skin around an ear or the headset twice or three times. Alternatively, the OWS headset supports a pinch operation, and performs interaction tasks such as making or answering a call and playing music by pinching the headset once, twice, or three times. For a complex interaction task like volume adjustment, the OWS headset cannot execute the task or execution efficiency is low. This affects user experience.

Therefore, how to improve a volume adjustment manner of the OWS headset is an important problem that needs to be resolved currently.

### SUMMARY

Disclosed embodiments provide a headset control method and a headset, to improve a volume adjustment manner and improve volume adjustment efficiency.

According to a first aspect, an embodiment provides a headset control method applicable to a headset. The method includes: detecting that a user triggers a first push operation of applying action force to the headset in a first direction or a second direction, and starting a volume adjustment function, where the first direction corresponds to a volume increase function in the volume adjustment function, and the second direction corresponds to a volume decrease function in the volume adjustment function; and after the volume adjustment function is started, detecting that duration of the action force of the first push operation is greater than or equal to first preset duration, and adjusting a volume level of the headset.

In this embodiment, the headset may start volume adjustment when detecting that the user triggers the first push operation on the headset. This improves a volume adjustment manner. In addition, the first push operation involves a small quantity of interaction contacts. This resolves a problem in the conventional technology that volume cannot be adjusted because the headset has a small quantity of interaction contacts. In addition, in this embodiment of this application, the headset may adaptively adjust the volume level of the headset (for example, based on the preset duration or the preset operation) when detecting that the duration of the action force of the first push operation is greater than or equal to the first preset duration. This improves volume adjustment efficiency.

For example, the volume level of the headset may include levels 0 to 100. Alternatively, for levels 0 to 100, the headset may adjust the volume three times every 20 levels. For example, when increasing from level 0 to level 20, the headset may adjust the volume three times to increase the volume to level 20 while maintaining the first push operation. During this period, the headset may play a volume increase prompt tone three times, to remind the user.

In an implementation, the first push operation may include an operation of tapping a control part of the headset and keeping in contact with the control part after the tapping. The control part includes a front-end ball or a rear-end ball of the headset, and the front-end ball is connected to the rear-end ball via a curved cantilever arm.

In an implementation, the first push operation may include an operation of touching the control part of the headset and then pushing the control part. The control part includes a front-end ball or a rear-end ball of the headset, and the front-end ball is connected to the rear-end ball via a curved cantilever arm.

In an implementation, adjusting the volume level of the headset includes: adjusting the volume level of the headset to a first volume level at a first moment; and adjusting the volume level of the headset to a second volume level at a second moment, where the second moment is later than the first moment.

In this implementation, the headset may adaptively adjust the volume level of the headset based on time. For example, when the first moment arrives, the volume level of the headset is adjusted to the first volume level; and when the second moment arrives, the volume level of the headset is adjusted to the second volume level. The rest may be deduced by analogy. This improves volume adjustment efficiency.

In an implementation, duration between the first moment and a moment at which the volume adjustment function is started is equal to second preset duration, and duration between the second moment and the first moment is equal to third preset duration.

In this implementation, when adaptively adjusting the volume level of the headset based on time, the headset may adjust the volume level of the headset at an interval of one piece of preset duration. Preset duration corresponding to initial adjustment of the volume level of the headset is the second preset duration, and preset duration corresponding to non-initial adjustment of the volume level of the headset is the third preset duration. The third preset duration may be less than or equal to the second preset duration. This reduces occurrence of an accidental touch of the user. Alternatively, the third preset duration may be greater than the second preset duration, so that sufficient time is reserved for the headset to detect the user operation for starting the volume adjustment function, to avoid a problem that user experience is poor because the user operation for starting the volume adjustment function is not detected.

In an implementation, the method further includes: detecting that the user cancels the first push operation on the headset, and closing the volume adjustment function.

In this implementation, a manner of closing volume adjustment is provided, and it is detected that the user cancels a previously triggered push operation on the headset (for example, cancels the first push operation on the headset).

In an implementation, adjusting the volume level of the headset includes: detecting that the user triggers a second push operation on the headset, and adjusting the volume level of the headset to a third volume level; and detecting that the user triggers a third push operation on the headset, and adjusting the volume level of the headset to a fourth volume level.

In this implementation, the headset may adaptively adjust the volume level of the headset based on the push operation triggered by the user on the headset. For example, when the user cancels the previously triggered first push operation on the headset and then triggers the second push operation on the headset, the volume level of the headset is adjusted to the third volume level; and when the user cancels the previously triggered second push operation on the headset and then triggers the third push operation on the headset, the volume level of the headset is adjusted to the fourth volume level. The rest may be deduced by analogy. This improves volume adjustment efficiency.

In an implementation, a moment at which it is detected that the user triggers the second push operation on the headset is a third moment, and duration between the third moment and the moment at which the volume adjustment function is started is less than or equal to fourth preset duration; and a moment at which it is detected that the user triggers the third push operation on the headset is a fourth moment, and duration between the fourth moment and the third moment is less than or equal to fifth preset duration.

In this implementation, when the headset may adaptively adjust the volume level of the headset based on the push operation triggered by the user on the headset, if it is detected, within one piece of preset duration, that the user triggers one push operation on the headset (that is, the headset is pushed after the headset is released), the volume level of the headset is adjusted once. Preset duration corresponding to initial adjustment of the volume level of the headset is the fourth preset duration, and preset duration corresponding to non-initial adjustment of the volume level of the headset is the fifth preset duration. The fifth preset duration may be less than or equal to the fourth preset duration. This reduces occurrence of an accidental touch of the user. Alternatively, the fifth preset duration may be greater than the fourth preset duration, so that sufficient time is reserved for the headset to detect the user operation for starting the volume adjustment function, to avoid a problem that user experience is poor because the user operation for starting the volume adjustment function is not detected.

In an implementation, the method further includes: detecting that the user triggers no fourth push operation on the headset within the fifth preset duration after the volume level of the headset is adjusted to the fourth volume level, and closing the volume adjustment function.

In this implementation, a manner of disabling volume adjustment is provided. A push operation on the headset that is re-triggered by the user is not detected within one piece of preset duration (for example, the third push operation on the headset is canceled and the fourth push operation on the headset is triggered).

In an implementation, duration between the moment at which the volume adjustment function is started and a moment at which the volume adjustment function is closed is less than or equal to a first threshold; or a quantity of times of adjusting the volume level of the headset is less than or equal to a second threshold.

In this implementation, duration (that is, the first threshold) of the volume adjustment function or a quantity of volume adjustment times (that is, the second threshold) is set. For example, the quantity of volume adjustment times is set to 3. In this case, after the current user starts the volume adjustment function, the volume can be adjusted for a maximum of three times. This resolves a problem that user experience is poor because a user operation of closing the volume adjustment function is not detected.

In an implementation, the volume increase function in the volume adjustment function is started. First volume is volume of the headset at the moment at which the volume adjustment function is started, and second volume is volume obtained by the headset based on ambient volume and/or historical volume. The method further includes: when the first volume is greater than or equal to the second volume, determining that a difference between volume values corresponding to adjacent volume levels is a third threshold, where the third threshold is a minimum volume adjustment value supported by the headset; or when the first volume is less than the second volume, and a difference between the first volume and the second volume is less than a fourth threshold, determining that a difference between volume values corresponding to adjacent volume levels is a difference between the first volume and the second volume, where the fourth threshold is a maximum volume adjustment value supported by the headset; or when the first volume is less than the second volume, and a difference between the first volume and the second volume is greater than or equal to a fourth threshold, determining that a difference between volume values corresponding to adjacent volume levels is the fourth threshold, where the fourth threshold is a maximum volume adjustment value supported by the headset.

In this implementation, when gradually increasing the volume of the headset, the headset may determine, based on whether the first volume is greater than the second volume and whether the difference between the first volume and the second volume is greater than the maximum volume adjustment value supported by the headset, the difference between the volume values corresponding to the adjacent volume levels. For example, the first volume is greater than or equal to the second volume. If the headset needs to play audio at the second volume, the volume should be decreased, but the user operation is to increase the volume. In consideration of user experience, the minimum volume adjustment value supported by the headset is selected as the difference between the volume values corresponding to the adjacent volume levels. The first volume is less than the second volume. If the headset needs to play audio at the second volume, the volume needs to be increased, and the user operation is also to increase the volume. Therefore, to adjust the volume to the second volume as soon as possible, if the difference between the first volume and the second volume is less than the maximum volume adjustment value supported by the headset, the difference between the first volume and the second volume is selected as the difference between the volume values corresponding to the adjacent volume levels. If the difference between the first volume and the second volume is greater than or equal to the maximum volume adjustment value supported by the headset, the maximum volume adjustment value supported by the headset is selected as the difference between the volume levels corresponding to the adjacent volume levels. This improves volume adjustment efficiency.

In an implementation, the volume decrease function in the volume adjustment function is started. First volume is volume of the headset at the moment at which the volume adjustment function is started, and second volume is volume obtained by the headset based on ambient volume and/or historical volume. The method further includes: when the first volume is less than or equal to the second volume, determining that a difference between volume values corresponding to adjacent volume levels is a third threshold, where the third threshold is a minimum volume adjustment value supported by the headset; or when the first volume is greater than the second volume, and a difference between the first volume and the second volume is less than a fourth threshold, determining that a difference between volume values corresponding to adjacent volume levels is a difference between the first volume and the second volume, where the fourth threshold is a maximum volume adjustment value supported by the headset; or when the first volume is greater than the second volume, and a difference between the first volume and the second volume is greater than or equal to a fourth threshold, determining that a difference between volume values corresponding to adjacent volume levels is the fourth threshold, where the fourth threshold is a maximum volume adjustment value supported by the headset.

In this implementation, when gradually decreasing the volume of the headset, the headset may determine, based on whether the first volume is greater than the second volume and whether the difference between the first volume and the second volume is greater than the maximum volume adjustment value supported by the headset, the difference between the volume values corresponding to the adjacent volume levels. For example, the first volume is less than or equal to the second volume. If the headset needs to play audio at the second volume, the volume should be increased, but the user operation is to decrease the volume. In consideration of user experience, the minimum volume adjustment value supported by the headset is selected as the difference between the volume values corresponding to the adjacent volume levels. The first volume is greater than the second volume. If the headset needs to play audio at the second volume, the volume needs to be decreased, and the user operation is also to decrease the volume. Therefore, to adjust the volume to the second volume as soon as possible, if the difference between the first volume and the second volume is less than the maximum volume adjustment value supported by the headset, the difference between the first volume and the second volume is selected as the difference between the volume values corresponding to the adjacent volume levels. If the difference between the first volume and the second volume is greater than or equal to the maximum volume adjustment value supported by the headset, the maximum volume adjustment value supported by the headset is selected as the difference between the volume levels corresponding to the adjacent volume levels. This improves volume adjustment efficiency.

According to a second aspect, an embodiment provides a headset control method. The method is applicable to a headset. The method includes: detecting that a user triggers a first push operation of applying action force to the headset in a first direction or a second direction, and starting a volume adjustment function, where the first direction corresponds to a volume increase function in the volume adjustment function, and the second direction corresponds to a volume decrease function in the volume adjustment function; and after the volume adjustment function is started, detecting that duration of the action force of the first push operation is less than first preset duration, and adjusting a volume level of the headset.

In an implementation, the first push operation may include an operation of tapping a control part of the headset and keeping in contact with the control part after the tapping. The control part includes a front-end ball or a rear-end ball of the headset, and the front-end ball is connected to the rear-end ball via a curved cantilever arm.

In an implementation, the first push operation may include an operation of touching the control part of the headset and then pushing the control part. The control part includes a front-end ball or a rear-end ball of the headset, and the front-end ball is connected to the rear-end ball via a curved cantilever arm.

In this embodiment, the headset may start volume adjustment when detecting that the user triggers the first push operation on the headset. This improves a volume adjustment manner. In addition, the first push operation involves a small quantity of interaction contacts. This resolves a problem in the conventional technology that volume cannot be adjusted because the headset has a small quantity of interaction contacts. In addition, in this embodiment of this application, the headset may adaptively adjust the volume level of the headset (for example, based on the preset operation) when detecting that the duration of the action force of the first push operation is less than the first preset duration. This improves volume adjustment efficiency.

In an implementation, adjusting the volume level of the headset includes: adjusting the volume level of the headset to a first volume level based on the first push operation; and detecting that the user triggers a second push operation on the headset, and adjusting the volume level of the headset to a second volume level.

In this implementation, the headset may adaptively adjust the volume level of the headset based on the push operation triggered by the user on the headset. For example, when the user cancels the previously triggered first push operation on the headset, the volume level of the headset is adjusted to the first volume level; and when the user triggers the second push operation on the headset, the volume level of the headset is adjusted to the fourth volume level. The rest may be deduced by analogy. This improves volume adjustment efficiency.

In an implementation, a moment at which the volume level of the headset is adjusted to the first volume level is a first moment, a moment at which it is detected that the user triggers the second push operation on the headset is a second moment, duration between the first moment and the second moment is first duration, and a sum of the first duration and duration of an action force of the second push operation is less than or equal to second preset duration.

In this implementation, when the headset may adaptively adjust the volume level of the headset based on the push operation triggered by the user on the headset, if it is detected, within one piece of preset duration, that the user triggers the push operation on the headset and cancels the push operation on the headset (that is, the headset is released after the headset is pushed), the volume level of the headset is adjusted once. Preset duration corresponding to initial adjustment of the volume level of the headset is the first preset duration, and preset duration corresponding to non-initial adjustment of the volume level of the headset is the second preset duration. The second preset duration may be less than or equal to the first preset duration. This reduces occurrence of an accidental touch of the user. Alternatively, the second preset duration may be greater than the first preset duration, so that sufficient time is reserved for the headset to detect the user operation for starting the volume adjustment function, to avoid a problem that user experience is poor because the user operation for starting the volume adjustment function is not detected.

In an implementation, the method further includes: detecting that the user triggers no third push operation on the headset within the second preset duration after the volume level of the headset is adjusted to the second volume level, and closing the volume adjustment function; or detecting that action force continuously applied by the user to the headset based on a third push operation within the second preset duration after the volume level of the headset is adjusted to the second volume level, and closing the volume adjustment function.

In this implementation, two manners of disabling volume adjustment are provided. For example, no push operation triggered by the user on the headset is detected within one piece of preset duration (for example, no third push operation triggered by the user on the headset is detected); or a push operation triggered by the user on the headset is detected within one piece of preset duration, but the push operation is not canceled (for example, it is detected that the user triggers the third push operation on the headset, but it is not detected that the user cancels the third push operation on the headset).

In an implementation, duration between a moment at which the volume adjustment function is started and a moment at which the volume adjustment function is closed is less than or equal to a first threshold; or a quantity of times of adjusting the volume level of the headset is less than or equal to a second threshold.

In this implementation, duration (that is, the first threshold) of the volume adjustment function or a quantity of volume adjustment times (that is, the second threshold) is set. For example, the quantity of volume adjustment times is set to 3. In this case, after the current user starts the volume adjustment function, the volume can be adjusted for a maximum of three times. This resolves a problem that user experience is poor because a user operation of closing the volume adjustment function is not detected.

In an implementation, the volume increase function in the volume adjustment function is started. First volume is volume of the headset at the moment at which the volume adjustment function is started, and second volume is volume obtained by the headset based on ambient volume and/or historical volume. The method further includes: when the first volume is greater than or equal to the second volume, determining that a difference between volume values corresponding to adjacent volume levels is a third threshold, where the third threshold is a minimum volume adjustment value supported by the headset; or when the first volume is less than the second volume, and a difference between the first volume and the second volume is less than a fourth threshold, determining that a difference between volume values corresponding to adjacent volume levels is a difference between the first volume and the second volume, where the fourth threshold is a maximum volume adjustment value supported by the headset; or when the first volume is less than the second volume, and a difference between the first volume and the second volume is greater than or equal to a fourth threshold, determining that a difference between volume values corresponding to adjacent volume levels is the fourth threshold, where the fourth threshold is a maximum volume adjustment value supported by the headset.

In this implementation, when gradually increasing the volume of the headset, the headset may determine, based on whether the first volume is greater than the second volume and whether the difference between the first volume and the second volume is greater than the maximum volume adjustment value supported by the headset, the difference between the volume values corresponding to the adjacent volume levels. For example, the first volume is greater than or equal to the second volume. If the headset needs to play audio at the second volume, the volume should be decreased, but the user operation is to increase the volume. In consideration of user experience, the minimum volume adjustment value supported by the headset is selected as the difference between the volume values corresponding to the adjacent volume levels. The first volume is less than the second volume. If the headset needs to play audio at the second volume, the volume needs to be increased, and the user operation is also to increase the volume. Therefore, to adjust the volume to the second volume as soon as possible, if the difference between the first volume and the second volume is less than the maximum volume adjustment value supported by the headset, the difference between the first volume and the second volume is selected as the difference between the volume values corresponding to the adjacent volume levels. If the difference between the first volume and the second volume is greater than or equal to the maximum volume adjustment value supported by the headset, the maximum volume adjustment value supported by the headset is selected as the difference between the volume levels corresponding to the adjacent volume levels. This improves volume adjustment efficiency.

In an implementation, the volume decrease function in the volume adjustment function is started. First volume is volume of the headset at the moment at which the volume adjustment function is started, and second volume is volume obtained by the headset based on ambient volume and/or historical volume. The method further includes: when the first volume is less than or equal to the second volume, determining that a difference between volume values corresponding to adjacent volume levels is a third threshold, where the third threshold is a minimum volume adjustment value supported by the headset; or when the first volume is greater than the second volume, and a difference between the first volume and the second volume is less than a fourth threshold, determining that a difference between volume values corresponding to adjacent volume levels is a difference between the first volume and the second volume, where the fourth threshold is a maximum volume adjustment value supported by the headset; or when the first volume is greater than the second volume, and a difference between the first volume and the second volume is greater than or equal to a fourth threshold, determining that a difference between volume values corresponding to adjacent volume levels is the fourth threshold, where the fourth threshold is a maximum volume adjustment value supported by the headset.

In this implementation, when gradually decreasing the volume of the headset, the headset may determine, based on whether the first volume is greater than the second volume and whether the difference between the first volume and the second volume is greater than the maximum volume adjustment value supported by the headset, the difference between the volume values corresponding to the adjacent volume levels. For example, the first volume is less than or equal to the second volume. If the headset needs to play audio at the second volume, the volume should be increased, but the user operation is to decrease the volume. In consideration of user experience, the minimum volume adjustment value supported by the headset is selected as the difference between the volume values corresponding to the adjacent volume levels. The first volume is greater than the second volume. If the headset needs to play audio at the second volume, the volume needs to be decreased, and the user operation is also to decrease the volume. Therefore, to adjust the volume to the second volume as soon as possible, if the difference between the first volume and the second volume is less than the maximum volume adjustment value supported by the headset, the difference between the first volume and the second volume is selected as the difference between the volume values corresponding to the adjacent volume levels. If the difference between the first volume and the second volume is greater than or equal to the maximum volume adjustment value supported by the headset, the maximum volume adjustment value supported by the headset is selected as the difference between the volume levels corresponding to the adjacent volume levels. This improves volume adjustment efficiency.

According to a third aspect, an embodiment provides a headset control method. The method is applicable to a headset. The method includes: triggering a second push operation on the headset after detecting that a user triggers a first push operation of applying action force to the headset in a first direction or a second direction, and starting a volume adjustment function, where the first direction corresponds to a volume increase function in the volume adjustment function, and the second direction corresponds to a volume decrease function in the volume adjustment function; and after the volume adjustment function is started, detecting that duration of action force of the second push operation is greater than or equal to first preset duration, and adjusting the volume level of the headset.

For beneficial effect of the third aspect and the possible designs of the third aspect, refer to the descriptions of the beneficial effect of the method according to any one of the first aspect and the possible designs of the first aspect.

According to a fourth aspect, an embodiment of this application further provides a headset control method. The method is applicable to a headset. The method includes: triggering a second push operation on the headset after detecting that a user triggers a first push operation of applying action force to the headset in a first direction or a second direction, and starting a volume adjustment function, where the first direction corresponds to a volume increase function in the volume adjustment function, and the second direction corresponds to a volume decrease function in the volume adjustment function; and after the volume adjustment function is started, detecting that duration of action force of the second push operation is less than first preset duration, and adjusting the volume level of the headset.

For beneficial effect of the fourth aspect and the possible designs of the fourth aspect, refer to the descriptions of the beneficial effect of the method according to any one of the second aspect and the possible designs of the second aspect.

According to a fifth aspect, an embodiment provides a headset control method. The method is applicable to a headset. The method includes: triggering a second push operation on the headset after detecting that the user triggers a first push operation of applying action force to the headset in a first direction or a second direction, and duration of action force of the second push operation is less than first preset duration, and starting a volume adjustment function, where the first direction corresponds to a volume increase function in the volume adjustment function, and the second direction corresponds to a volume decrease function in the volume adjustment function; and after the volume adjustment function is started, detecting that the user triggers a third push operation on the headset, and duration of action force of the third push operation is less than the first preset duration, and adjusting the volume level of the headset.

For beneficial effect of the fifth aspect and the possible designs of the fifth aspect, refer to the descriptions of the beneficial effect of the method according to any one of the second aspect and the possible designs of the second aspect.

According to a sixth aspect, an embodiment provides a headset control method. The method is applicable to a headset. The method includes: detecting that a user triggers a first push operation of applying action force to the headset in a first direction or a second direction, and duration of the action force of the first push operation is less than first preset duration, and starting a volume adjustment function, where the first direction corresponds to a volume increase function in the volume adjustment function, and the second direction corresponds to a volume decrease function in the volume adjustment function; and after the volume adjustment function is started, detecting that the user triggers a second push operation on the headset, and duration of action force of the second push operation is less than the first preset duration, and adjusting the volume level of the headset.

For beneficial effect of the sixth aspect and the possible designs of the sixth aspect, refer to the descriptions of the beneficial effect of the method according to any one of the second aspect and the possible designs of the second aspect.

According to a seventh aspect, an embodiment provides a headset control apparatus. The headset control apparatus has a function of implementing behavior in the method embodiment described in the first aspect or any possible design of the first aspect, the second aspect or any possible design of the second aspect, the third aspect or any possible design of the third aspect, the fourth aspect or any possible design of the fourth aspect, the fifth aspect or any possible design of the fifth aspect, or the sixth aspect or any possible design of the sixth aspect. The headset control apparatus may be the headset according to the first aspect, the second aspect, the third aspect, the fourth aspect, the fifth aspect, or the sixth aspect, or a functional module (for example, a chip system) configured in the headset, or a larger device including the headset. The headset includes a corresponding means (means) or module configured to perform the foregoing method. For example, the headset control apparatus may include a processing unit (also referred to as a processing module sometimes) and a transceiver unit (also referred to as a transceiver module sometimes).

Optionally, the processing unit is configured to: detect that a user triggers a first push operation of applying action force to the headset in a first direction or a second direction, and start a volume adjustment function, where the first direction corresponds to a volume increase function in the volume adjustment function, and the second direction corresponds to a volume decrease function in the volume adjustment function; and after the volume adjustment function is started, detect that duration of the action force of the first push operation is greater than or equal to first preset duration, and adjust a volume level of the headset.

Optionally, the processing unit is configured to: detect that a user triggers a first push operation of applying action force to the headset in a first direction or a second direction, and start a volume adjustment function, where the first direction corresponds to a volume increase function in the volume adjustment function, and the second direction corresponds to a volume decrease function in the volume adjustment function; and after the volume adjustment function is started, detect that the duration of the action force of the first push operation is less than first preset duration, and adjust a volume level of the headset.

Optionally, the processing unit is configured to: trigger a second push operation on the headset after detecting that a user triggers a first push operation of applying action force to the headset in a first direction or a second direction, and start a volume adjustment function, where the first direction corresponds to a volume increase function in the volume adjustment function, and the second direction corresponds to a volume decrease function in the volume adjustment function; and after the volume adjustment function is started, detect that duration of action force of the second push operation is greater than or equal to first preset duration, and adjust a volume level of the headset.

Optionally, the processing unit is configured to: trigger a second push operation on the headset after detecting that a user triggers a first push operation of applying action force to the headset in a first direction or a second direction, and start a volume adjustment function, where the first direction corresponds to a volume increase function in the volume adjustment function, and the second direction corresponds to a volume decrease function in the volume adjustment function; and after the volume adjustment function is started, detect that the duration of the action force of the second push operation is less than first preset duration, and adjust a volume level of the headset.

Optionally, the processing unit is configured to: trigger a second push operation on the headset after detecting that the user triggers a first push operation of applying action force to the headset in a first direction or a second direction, and duration of action force of the second push operation is less than first preset duration, and start the volume adjustment function, where the first direction corresponds to a volume increase function in the volume adjustment function, and the second direction corresponds to a volume decrease function in the volume adjustment function; and after the volume adjustment function is started, detect that the user triggers a third push operation on the headset, and duration of action force of the third push operation is less than the first preset duration, and adjust a volume level of the headset.

Optionally, the processing unit is configured to: detect that a user triggers a first push operation of applying action force to the headset in a first direction or a second direction, and duration of the action force of the first push operation is less than first preset duration, and start the volume adjustment function, where the first direction corresponds to a volume increase function in the volume adjustment function, and the second direction corresponds to a volume decrease function in the volume adjustment function; and after the volume adjustment function is started, detect that the user triggers a second push operation on the headset, and duration of action force of the second push operation is less than the first preset duration, and adjust a volume level of the headset.

According to an eighth aspect, an embodiment provides a headset. The headset includes a processor, a memory, and one or more programs. The one or more programs are stored in the memory, and the one or more programs include instructions. When the instructions are executed by the processor, the headset is enabled to perform the method described in the first aspect or any possible design of the first aspect, the second aspect or any possible design of the second aspect, the third aspect or any possible design of the third aspect, the fourth aspect or any possible design of the fourth aspect, the fifth aspect or any possible design of the fifth aspect, or the sixth aspect or any possible design of the sixth aspect.

According to a ninth aspect, an embodiment provides a computer-readable storage medium. The computer-readable storage medium is configured to store a computer program. When the computer program runs on a computer, the computer is enabled to perform the method described in the first aspect or any possible design of the first aspect, the second aspect or any possible design of the second aspect, the third aspect or any possible design of the third aspect, the fourth aspect or any possible design of the fourth aspect, the fifth aspect or any possible design of the fifth aspect, or the sixth aspect or any possible design of the sixth aspect.

According to a tenth aspect, an embodiment provides a computer program product, including a computer program. When the computer program runs on a computer, the computer is enabled to perform the method described in the first aspect or any possible design of the first aspect, the second aspect or any possible design of the second aspect, the third aspect or any possible design of the third aspect, the fourth aspect or any possible design of the fourth aspect, the fifth aspect or any possible design of the fifth aspect, or the sixth aspect or any possible design of the sixth aspect.

According to an eleventh aspect, an embodiment provides a chip system, including a processor and an interface. The processor is configured to invoke instructions from the interface and run the instructions, so that the chip system performs the method described in the first aspect or any possible design of the first aspect, the second aspect or any possible design of the second aspect, the third aspect or any possible design of the third aspect, the fourth aspect or any possible design of the fourth aspect, the fifth aspect or any possible design of the fifth aspect, or the sixth aspect or any possible design of the sixth aspect.

A twelfth aspect provides a headset control method, which may be applied to an open-ear headset. The method may include: starting a volume adjustment function in response to a first push operation of tapping and holding a front-end ball of the headset in a first direction. The front-end ball and a rear-end ball are connected via a curved cantilever arm. A volume level of the open-ear headset is increased if duration of the first push operation is greater than or equal to preset duration. In view of this, a user may adjust volume of the headset by pushing the open-ear headset through a finger, to conform to a habit of naturally swinging the arm of the user forward and backward. In comparison with another volume adjustment manner, volume adjustment operation difficulty can also be reduced.

In an implementation, the method further includes: starting the volume adjustment function in response to a second push operation of tapping and holding the rear-end ball in a second direction, where the second direction is different from the first direction. The volume level of the open-ear headset is decreased if duration of the second push operation is greater than or equal to the preset duration.

In an implementation, the method may further include: after the volume adjustment function is started, increasing the volume level of the open-ear headset in response to the operation of tapping the front-end ball in the first direction.

A thirteenth aspect provides a headset control method, which may be applied to an open-ear headset. The method may include: starting a volume adjustment function in response to a first push operation of tapping and holding a rear-end ball of the headset in a first direction. The rear-end ball and a front-end ball are connected via a curved cantilever arm. A volume level of the open-ear headset is increased if duration of the first push operation is greater than or equal to preset duration. In view of this, the user may adjust the volume of the headset by pushing the open-ear headset through a finger, to conform to a habit of naturally swinging the arm of the user forward and backward. In comparison with another volume adjustment manner, volume adjustment operation difficulty can also be reduced.

In an implementation, the method further includes: starting the volume adjustment function in response to a second push operation of tapping and holding the front-end ball in a second direction, where the second direction is different from the first direction. The volume level of the open-ear headset is decreased if duration of the second push operation is greater than or equal to the preset duration.

In an implementation, the method may further include: after the volume adjustment function is started, increasing the volume level of the open-ear headset in response to the operation of tapping the rear-end ball in the first direction.

It should be understood that, in embodiments in the foregoing plurality of aspects, the recorded step of starting the volume adjustment function may also be properly skipped. In the foregoing methods, the volume level of the headset may be directly adjusted when the volume adjustment function is started.

In some examples, for the method provided in the first aspect, for the push operation of continuously applying the action force in the first direction, the headset may directly increase the volume of the headset when the push operation meets preset duration. Correspondingly, for the push operation of continuously applying the action force in the second direction, the headset may directly decrease the volume of the headset when the push operation meets the preset duration. An implementation provided in another aspect may also be understood by analogy.

### BRIEF DESCRIPTION OF DRAWINGS

FIG. 1 is a diagram of a headset control system according to an embodiment;

FIG. 2 is a diagram of a structure of a headset 100 according to an embodiment;

FIG. 3 is a diagram of a form of a headset 100 according to an embodiment;

FIG. 4 is a diagram of interaction of a headset 100 according to an embodiment;

FIG. 5 is a diagram of interaction of starting volume adjustment according to an embodiment;

FIG. 6 is a diagram of an interface for starting audio playing according to an embodiment;

FIG. 7 is a schematic flowchart of volume adjustment according to an embodiment;

FIG. 8 is another schematic flowchart of volume adjustment according to an embodiment;

FIG. 9 is still another schematic flowchart of volume adjustment according to an embodiment;

FIG. 10 is yet another schematic flowchart of volume adjustment according to an embodiment;

FIG. 11 is still yet another schematic flowchart of volume adjustment according to an embodiment;

FIG. 12 is a diagram of a volume adjustment curve according to an embodiment;

FIG. 13 is a diagram of a user interface according to an embodiment;

FIG. 14 is a diagram of a volume adjustment scenario according to an embodiment;

FIG. 15 is a diagram of another volume adjustment scenario according to an embodiment;

FIG. 16 is a schematic flowchart of a headset control method according to an embodiment; and

FIG. 17 is a diagram of a structure of a headset according to an embodiment.

### DESCRIPTION OF EMBODIMENTS

The following describes some terms in embodiments of this disclosure to facilitate understanding of a person skilled in the art.

In the disclosed embodiments, reference to “at least one” includes one or more, and “a plurality of” means two or more. In addition, it should be understood that in descriptions of this specification, terms such as “first” and “second” are merely intended for distinguishing a purpose of description and should not be understood as indication or implication of relative importance, or indication or implication of order. For example, a first operation and a second operation do not represent importance of the first operation and the second operation or represent a sequence of the first operation and the second operation, and are merely used for distinguishing between descriptions. The term “and/or” in disclosed embodiments describes only an association relationship and represents that three relationships may exist. For example, A and/or B may represent the following three cases: Only A exists, both A and B exist, and only B exists. In addition, the character “/” in this specification generally indicates an “or” relationship between the associated objects.

In the descriptions of embodiments, it should be noted that terms “installation” and “connection” should be understood in a broad sense unless there is a clear stipulation and limitation. For example, “connection” may be a detachable connection, a nondetachable connection, a direct connection, or an indirect connection through an intermediate medium. The orientation terms mentioned in embodiments of this application, for example, “up”, “down”, “left”, “right”, “inside”, and “outside”, are merely directions based on the accompanying drawings. Therefore, the orientation terms are used to better and more clearly describe and understand embodiments of this disclosure, instead of indicating or implying that a specified apparatus or element should have a specific orientation and be constructed and operated in a specific orientation. Therefore, this cannot be understood as a limitation with respect to any embodiments of this disclosure.

Reference to “an embodiment”, “some embodiments”, or the like described in this specification means that specific features, structures, or characteristics described with reference to the embodiment are included in one or more embodiments of this specification. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. Terms “include”, “contain”, “have”, and their variants all mean “include but are not limited to”, unless otherwise specifically emphasized in another manner.

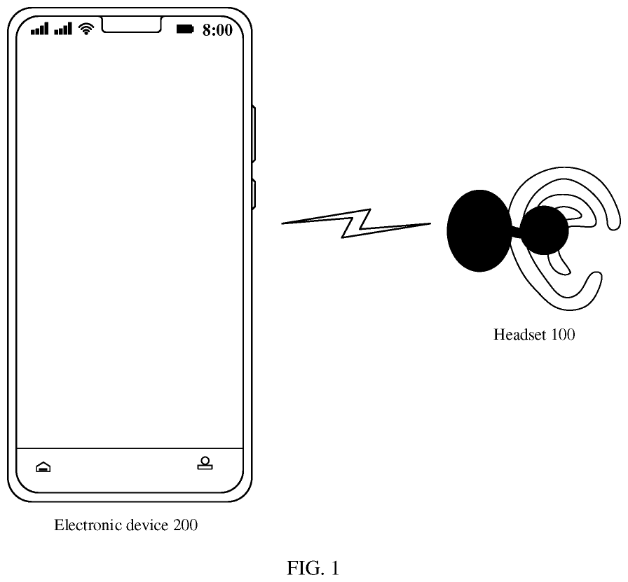

A headset control method provided in embodiments of this disclosure is applicable to a headset control system. For example, FIG. 1 is a diagram of a headset control system according to an embodiment of this application. As shown in FIG. 1, the headset control system may include a headset 100 and an electronic device 200. A wireless connection may be established between the headset 100 and the electronic device 200. The wireless connection is a connection established by using a wireless communication technology. The wireless communication technology may be Bluetooth (BT), a wireless local area network (WLAN) (for example, a wireless fidelity (Wi-Fi®) network)), frequency modulation (FM), near field communication (NFC), an infrared (IR) technology, or the like. A type of the wireless communication technology is not specifically limited in embodiments of this application.

The headset 100 may be a wireless headset, for example, may be a true wireless stereo (true wireless stereo, TWS) headset, or may be an open wearable stereo (OWS) headset. A specific type of the headset is not limited in embodiments of this application. A device form of the TWS headset is different from a device form of the OWS headset. For example, the TWS headset uses an in-ear structure or a semi-in-ear structure. The OWS headset uses a non-in-ear structure, and has products in different forms around a periphery of an ear, an auricle, and an inner ear. The OWS headset and the TWS headset have different interaction contacts due to different device forms. Therefore, for basic interaction tasks such as making or answering a call, playing music, reducing noise, and adjusting volume for the headset, the OWS headset and the TWS headset have different support capabilities. For ease of description, in FIG. 1, an example in which the headset 100 is an OWS headset is used.

The electronic device 200 may be a portable electronic device like a mobile phone, a tablet computer, or a notebook computer, or may be a wearable device like a watch or a band, or may be a smart home device like a television or a refrigerator, or may be a vehicle-mounted device or the like, or may be a virtual reality (VR) device, an augmented reality (augmented reality, AR) device, or a mixed reality (MR) device. In conclusion, a specific type of the electronic device is not limited in embodiments of this application. For ease of description, in FIG. 1, an example in which the electronic device 200 is a mobile phone is used.

It should be understood that FIG. 1 shows only an example of a headset control system for ease of understanding. However, this should not constitute any limitation on this application. The headset control system may further include more headsets, or may include more electronic devices. Electronic devices interacting with different headsets may be a same electronic device, or may be different electronic devices. Quantities of electronic devices interacting with different headsets may be the same or may be different. This is not limited in embodiments of this application.

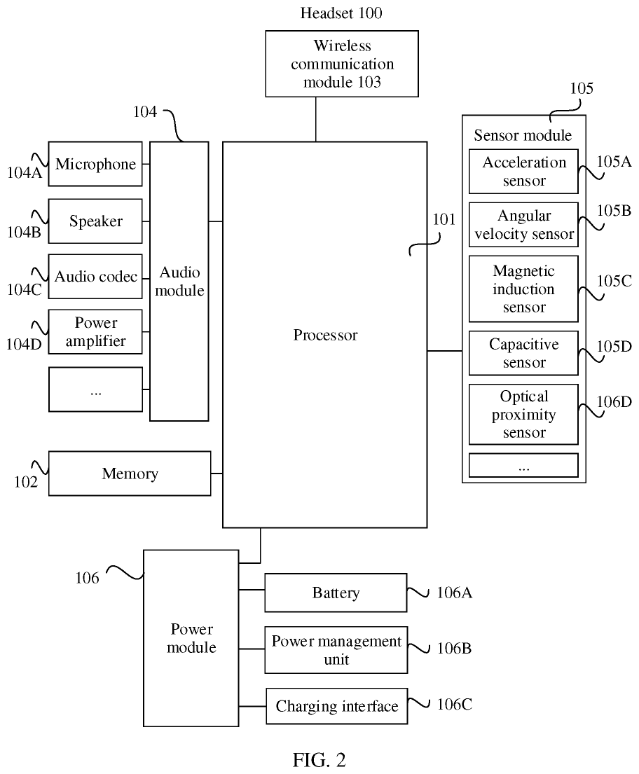

For example, FIG. 2 is a diagram of a structure of a headset 100 according to an embodiment of this application. As shown in FIG. 2, the headset 100 may include at least one processor 101, at least one memory 102, a wireless communication module 103, an audio module 104, a sensor module 105, a power module 106, and the like. The processor may include one or more interfaces, configured to connect to another component of the headset 100.

The memory 102 may be configured to store program code, for example, program code used to establish wireless connections between the headset 100 and different electronic devices, where the wireless connection may be a physical connection or a virtual connection, program code used to switch the wireless connections between the headset 100 and the different electronic devices, program code used by the headset 100 to process an audio service (for example, volume adjustment, music playing, and answering/making a call) of an electronic device that establishes a wireless connection to the headset 100, and program code used to charge the headset 100. The memory 102 may be further configured to store other information, for example, priorities of a plurality of electronic devices.

The processor 101 may be configured to execute the program code, and invoke a related module to implement a function of the headset 100 in this embodiment. For example, the headset 100 establishes the wireless connections to the different electronic devices, processes audio services (for example, volume adjustment, music playing, and answering/making a call) of the electronic devices that establish the wireless connections to the headset 100, and switches functions such as the wireless connections to different electronic devices based on priorities.

The processor 101 may include one or more processing units. Different processing units may be independent components, or may be integrated into one or more processors 101. The processor 101 may be an integrated control chip, or may include a circuit including various active components and/or passive components, and the circuit is configured to perform the functions of the processor 101 and that are described in this embodiment.

The wireless communication module 103 may be configured to support data exchange between the headset 100 and different electronic devices or data exchange within the headset 100, including data exchange of wireless communication such as BT, a WLAN (for example, Wi-Fi®), FM, NFC, and IR.

In some embodiments, the wireless communication module 103 may be a Bluetooth chip. The headset 100 may be paired with and establish wireless connections to Bluetooth chips of different electronic devices via the Bluetooth chip, to implement wireless communication and service processing between the headset 100 and the other electronic devices through the wireless connections. Generally, the Bluetooth chip may support a basic rate (BR)/enhanced data rate (EDR) Bluetooth and Bluetooth low energy (BLE), for example, may receive/send paging information and receive/send a BLE broadcast message.

In addition, the wireless communication module 103 may further include an antenna. The wireless communication module 103 receives an electromagnetic wave through the antenna, performs frequency modulation and filtering processing on an electromagnetic wave signal, and sends a processed signal to the processor 101. The wireless communication module 103 may further receive a to-be-sent signal from the processor 101, perform frequency modulation and amplification on the to-be-sent signal, and convert the signal into an electromagnetic wave for radiation through the antenna.

The audio module 104 may be configured to: manage audio data, implement input and output of an audio signal of the headset 100, and implement functions such as making or answering a call, playing music, and adjusting volume via the headset 100, enabling/disabling a voice assistant of an electronic device connected to the headset 100, and receiving/sending voice data of a user via the headset 100. The audio module 104 may include a microphone 104A (or referred to as a mike or a mic) configured to output an audio signal, a speaker 104B (or referred to as an earpiece or a receiver) component, an audio codec 104C, a power amplifier 104D, and the like. The microphone 104A may be configured to convert a sound signal into an audio electrical signal. The speaker 104B may be configured to convert an audio electrical signal into a sound signal and play the sound signal. The audio codec 104C converts a digital signal into an analog signal and sends the analog signal to the power amplifier. The power amplifier 104D may be configured to amplify an analog signal.

The sensor module 105 may detect information required by the headset 100 based on different functions of the headset 100. For example, the user pushes the headset 100 to implement function control like volume adjustment, music playing, or making or answering a call, and the processor 101 identifies an operation intent of the user by collecting data of a motion sensor and a capacitive sensor 105D of the headset 100.

The motion sensor of the headset 100 may include an acceleration sensor 105A, an angular velocity sensor 105B, and a magnetic induction sensor 105C. For example, the processor 101 may collect, in real time via the acceleration sensor 105A, acceleration values of the headset 100 on three axes x, y, and z, to calculate a posture of the headset 100. Alternatively, the processor 101 may collect an angular velocity value of the headset 100 in real time via the angular velocity sensor 105B, to calculate a posture of the headset 100 by performing time integration. Alternatively, the processor 101 may collect magnetic field strength information of the headset 100 via the magnetic induction sensor 105C, to calculate a posture of the headset 100. Regardless of the acceleration sensor 105A, the angular velocity sensor 105B, or the magnetic induction sensor 105C, motion information collected via these sensors can meet precision required for posture recognition of the headset 100. In this embodiment of this application, the three types of sensors may be separately used or used in combination to achieve different objectives such as low power consumption or high precision.

The capacitive sensor 105D may be configured to detect pressure on a pressing region of the headset 100. The pressing region is a region corresponding to an electrode plate of the capacitive sensor 105D. When a user of the headset 100 presses the pressing region, the electrode plate of the capacitive sensor 105D deforms, so that capacitance of the capacitive sensor 105D can change based on a change of pressure borne by the pressing region. There may be one capacitive sensor 105D, or there may be two or more capacitive sensors 105D. A quantity of the capacitive sensors 105D is specifically determined based on a requirement of the headset 100.

An optical proximity sensor 106D may be configured to determine whether the headset 100 is worn by the user. In some embodiments, the sensor module 105 may further include a distance sensor, and the distance sensor may be configured to detect whether there is an object near the headset 100, to determine whether the headset 100 is worn by the user. When it is determined that the headset 100 is worn, the headset 100 may start the speaker 104B to make a prompt tone.

For another example, the sensor module 105 may further include a bone conduction sensor. The headset 100 may obtain a vibration signal of a vibration bone of a human vocal part via the bone conduction sensor, obtain a voice signal through parsing, and implement a voice function, to receive a voice instruction of the user. The headset 100 may further perform voice authentication based on a user voice signal obtained by the bone conduction sensor, to authenticate a user identity in a service scenario like a payment transaction scenario.

For another example, the sensor module 105 may further include: a touch sensor, configured to detect a touch operation of the user, like a single tap operation, a double-tap operation, a multi-tap operation, a touch and hold operation, or a heavy press operation, and further configured to perform user fingerprint recognition, to authenticate a user identity in a service scenario like a payment transaction scenario; a fingerprint sensor, configured to detect a user fingerprint, identify a user identity, and the like; an ambient optical sensor, configured to adaptively adjust some parameters (for example, volume) based on perceived ambient light brightness; and some other sensors.

The power module 106 may be configured to provide a system power supply of the headset 100, supply power to each module of the headset 100, support the headset 100 in receiving a charging input, and the like. The power module 106 may include a battery 106A, a power management unit (PMU) 106B, and a charging interface 106C. The power management unit 106B may receive an external charging input; perform voltage transformation on an electrical signal input by a charging circuit, and then provide a transformed electrical signal to the battery 106A for charging, and may perform voltage transformation on an electrical signal provided by the battery 106A, and then provide a transformed electrical signal to other modules like the wireless communication module 103, the audio module 104, and the sensor module 105; and avoid overcharge, overdischarge, a short circuit, overcurrent, or the like of the battery 106A. In some embodiments, the power module 106 may further include a wireless charging coil, configured to wirelessly charge the headset 100. In addition, the power management unit 106B may be further configured to monitor parameters such as a capacity of the battery 106A, a quantity of cycles of the battery 106A, and a state of health (electric leakage or impedance) of the battery 106A. The charging interface 106C may be configured to provide a wired connection for charging or communication between the headset 100 and a headset box. In some embodiments, an input/output interface may be a USB port. In some other embodiments, the charging interface 106C may be a headset electrical connector. When the headset 100 is placed in the headset box, the headset 100 may establish an electrical connection to an electrical connector in the headset box via the headset electrical connector, to charge the battery 106A in the headset 100. In some other embodiments, after the electrical connection is established, the headset 100 may further perform data communication with the headset box, for example, may receive a pairing instruction from the headset box.

It may be understood that the structure shown in this embodiment of this application does not constitute a specific limitation on the headset 100. The headset 100 may have more or fewer components than those shown in FIG. 2, or combine two or more components, or have different component configurations. For example, an outer surface of the headset 100 may further include components such as a button, an indicator (which may indicate a battery level, an incoming/outgoing call, a pairing mode, and the like), a display (which may prompt related information of the user), and a dust filter (which may be used together with the earpiece). The button may be a physical button, a touch button (used in cooperation with the touch sensor), or the like, and is configured to trigger operations such as power-on, power-off, pause, play, record, start pairing, and reset.

The various components shown in FIG. 2 may be implemented in hardware, software, or a combination of hardware and software including one or more signal processing circuits or application-specific integrated circuits.

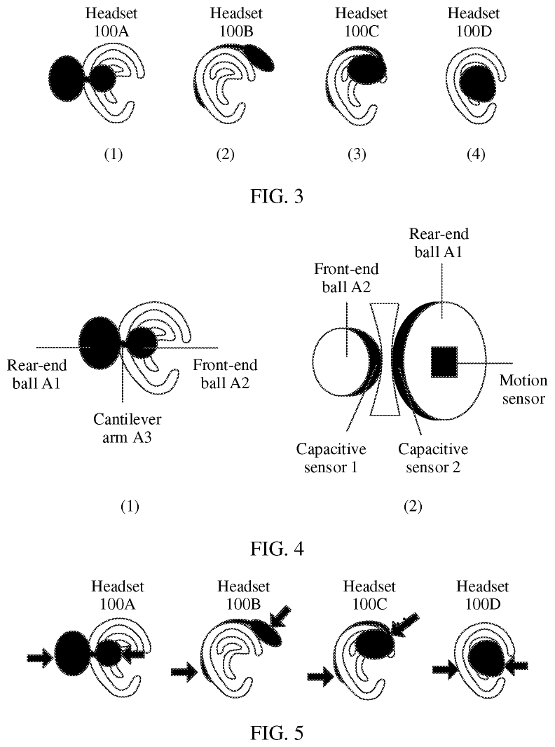

For example, FIG. 3 is a diagram of a form of a headset 100 according to an embodiment of this application. The headset 100 may include four forms: a headset 100A, a headset 100B, a headset 100C, and a headset 100D. The headset 100A shown in (1) in FIG. 3 may be clamped on an auricle. The headset 100B shown in (2) in FIG. 3 may surround the back of the ear and be closely attached to the skin above the sideburns (below the temple). The headset 100C shown in (3) in FIG. 3 may surround the back of the ear and loops back the vicinity of a triangular fossa above a helix. The headset 100D shown in (4) in FIG. 3 may be inserted into a concha cavity.

FIG. 4 is a diagram of interaction of a headset 100 according to an embodiment of this disclosure. The headset 100A shown in (1) in FIG. 3 is used as an example. As shown in (1) in FIG. 4, the headset 100A mainly includes two spherical structures (referred to as a rear-end ball A1 and a front-end ball A2) and one cantilever (referred to as a cantilever arm A3) that connects the two spherical structures. As shown in (2) in FIG. 4, the rear-end ball A1 is located behind the auricle. In the headset 100A, a capacitive sensor 1 may be disposed on a side that is of the rear-end ball A1 and that is close to the auricle, and a motion sensor may be disposed in the rear-end ball A1. The front-end ball A2 is located in the auricle, and in the headset 100A, a capacitive sensor 2 may be disposed on a side that is of the front-end ball A2 and that is close to the auricle.

Refer to (1), (2), and (3) in FIG. 3. In a possible implementation, the cantilever arm of the headset is curved, one end is connected to the front-end ball, and the other end is connected to the rear-end ball. It should be understood that, when the user wears the headset, the front-end ball may be in contact with the user's ear, the curved cantilever arm may be disposed around a contour of the user's ear, and the rear-end ball abuts against the user's ear. In this case, the headset may be clamped on the user's ear, to implement wearing.

The capacitive sensor 1 and the capacitive sensor 2 may be configured to detect a contact area between the headset 100A and ear skin. For example, in a process of interaction between the user and the headset 100A, the user presses the capacitive sensor 1 when pushing the rear-end ball forward, so that a contact area between the capacitive sensor 1 and the ear skin increases, and capacitance of the capacitive sensor 1 also increases accordingly. It may be understood as that when the capacitance of the capacitive sensor 1 increases, the contact area between the capacitive sensor 1 and the ear skin increases. Alternatively, the user presses the capacitive sensor 2 when pushing the front-end ball backward, so that a contact area between the capacitive sensor 2 and ear skin increases, and capacitance of the capacitive sensor 2 also increases accordingly. It may be understood as that when the capacitance of the capacitive sensor 2 increases, the contact area between the capacitive sensor 2 and the ear skin increases.

The motion sensor may be configured to detect a posture of the headset 100A. For example, in a process of interaction between the user and the headset 100A, when the user pushes the rear-end ball forward, it may be calculated, based on an acceleration value, an angular velocity value, or magnetic field strength information that is of the headset 100A and that is collected by the motion sensor in this case, that a movement direction of the headset 100 is forward movement. Alternatively, when the user pushes the front-end ball backward, it may be calculated, based on an acceleration value, an angular velocity value, or magnetic field strength information that is of the headset 100A and that is collected by the motion sensor in this case, that a movement direction of the headset 100 is backward movement.

The following further describes the headset control method provided in embodiments of this disclosure with reference to the headset control system shown in FIG. 1 and the headsets shown in FIG. 2 to FIG. 4.

The headset control method provided in embodiments of this disclosure is used to adjust volume of audio played by the headset, switch audio played by the headset, and the like.

In Embodiment 1, an example in which the headset control method provided in embodiments of this application is used to adjust the volume of the audio played by the headset is used. An execution process of adjusting the volume of the audio played by the headset includes at least two phases: volume adjustment start and volume adjustment. The following describes in detail the method in each phase.

### 1. Start Volume Adjustment

In this embodiment, the headset may start a volume adjustment function when a first condition is met.

A push operation is an operation of applying action force to the headset in a first direction or a second direction, and the first condition may include but is not limited to one or more of the following:

Detecting that a user triggers a first push operation may be understood as that the user does not cancel the first push operation after triggering the first push operation. For example, the user pushes a rear-end ball of the headset forward (pushes), that is, the rear-end ball remains in a pushed state after the user performs one push operation on the headset.

Alternatively, detecting that the user triggers a first push operation and duration of action force of the first push operation is less than first preset duration may be understood as that the user cancels the first push operation after triggering the first push operation. For example, the user pushes the rear-end ball of the headset forward, and then releases the rear-end ball of the headset (that is, pushes and releases), that is, the rear-end ball remains in a released state after the user performs one push operation on the headset.

Alternatively, detecting that the user triggers a first push operation and then triggers a second push operation may be understood as that the user triggers the first push operation and then cancels the first push operation, and then triggers the second push operation. For example, the user pushes a rear-end ball of the headset forward, releases the rear-end ball of the headset, and pushes the rear-end ball of the headset forward again (pushes, releases, and pushes), that is, the rear-end ball remains in a pushed state after the user performs two push operations on the headset.

Alternatively, detecting that the user triggers a first push operation and then triggers a second push operation, and duration of action force of the second push operation is less than first preset duration may be understood as that the user triggers the first push operation and then cancels the first push operation, and triggers the second push operation and then cancels the second push operation. For example, the user pushes a rear-end ball of the headset forward, releases the rear-end ball of the headset, pushes the rear-end ball of the headset forward again, and releases the rear-end ball of the headset again (pushes, releases, pushes, and releases), that is, the rear-end ball remains in a released state after the user performs two push operations on the headset.

The volume adjustment function may include a volume increase function and a volume decrease function. That the volume increase function corresponds to the first direction may be understood as that when a push operation is an operation of applying action force to the headset in the first direction, a volume adjustment function started by the headset when a first condition corresponding to the push operation is met is the volume increase function. That the volume decrease function corresponds to the second direction may be understood as that when a push operation is an operation of applying action force to the headset in the second direction, a volume adjustment function started by the headset when a first condition corresponding to the push operation is met is the volume decrease function.

For example, FIG. 5 is a diagram of interaction of starting volume adjustment according to an embodiment of this application. As shown in FIG. 5, an example in which the headset is the headset 100A shown in (1) in FIG. 3 is used. The user may push a rear-end ball of the headset 100A forward to start a volume increase function, or the user may push a front-end ball of the headset 100A backward to start a volume decrease function. Alternatively, an example in which the headset is the headset 100B shown in (2) in FIG. 3 is used. The user may push a behind-the-ear component of the headset 100B forward to start the volume increase function, or the user may push a component that is above the sideburns and that is of the headset 100B backward to start the volume decrease function. Alternatively, an example in which the headset is the headset 100C shown in (3) in FIG. 3 is used. The user may push a behind-the-ear component of the headset 100C forward to start the volume increase function, or the user may push a component above a triangular fossa of the headset 100C backward to start the volume decrease function. Alternatively, an example in which the headset is the headset 100D shown in (4) in FIG. 3 is used. The user may push an auricle forward to start the volume increase function, or the user may push the headset 100D backward to start the volume decrease function.

During specific implementation, the headset may detect, by collecting data of each sensor (for example, a capacitive sensor, a motion sensor, a bone conduction sensor, or a touch sensor) of the headset, a push operation triggered by the user on the headset and duration of action force of the push operation. For example, the headset is the headset 100A shown in (1) in FIG. 3. When the user pushes the rear-end ball of the headset 100A forward to start the volume increase function, a capacitive sensor 1 disposed on a side that is of the rear-end ball and that is close to the auricle is pressed, so that a contact area between the capacitive sensor 1 and ear skin increases, and capacitance of the capacitive sensor 1 also increases accordingly. It may be understood as that when the capacitance of the capacitive sensor 1 increases, the headset 100A may detect that the user pushes the rear-end ball of the headset 100A forward. Alternatively, when the user pushes the front-end ball of the headset 100A backward to start the volume decrease function, a capacitive sensor 2 disposed on a side that is of the front-end ball and that is close to the auricle is pressed, so that a contact area between the capacitive sensor 2 and ear skin increases, and capacitance of the capacitive sensor 2 also increases accordingly. It may be understood as that when the capacitance of the capacitive sensor 2 increases, the headset 100A may detect that the user pushes the front-end ball of the headset 100A backward.

In a possible implementation, before the headset starts the volume adjustment function, the headset may receive a play instruction for first audio from a mobile phone, and play the first audio at an initial volume level. The first audio may include but is not limited to one or more of the following: an incoming call ringtone, multimedia audio (for example, a sound output by a music application or a video application), a call voice, or a voice message. The initial volume level may be a default volume level of the headset, or may be a volume level determined after the user adjusts volume of the headset last time. This is not specifically limited in embodiments of this application.

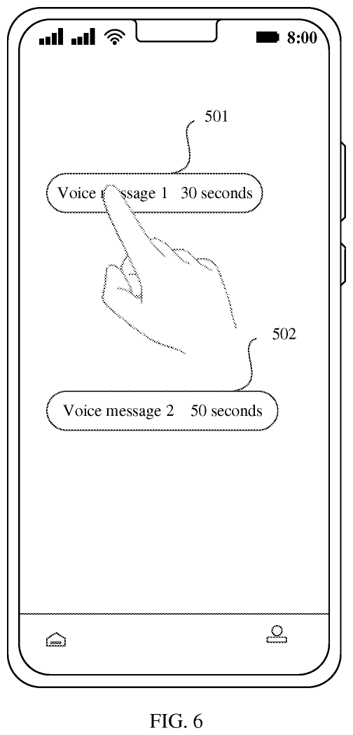

For example, the mobile phone may receive an incoming call, and send a play instruction for an incoming call ringtone to the headset. Correspondingly, the headset may receive the play instruction for the incoming call ringtone from the mobile phone, and play the incoming call ringtone at the initial volume level. For another example, FIG. 6 is a diagram of an interface for starting audio playing according to an embodiment of this application. As shown in FIG. 6, the mobile phone may display bubbles of two voice messages on a display: a voice message 1 and a voice message 2. Total duration of the voice message 1 is 30 seconds, and total duration of the voice message 2 is 50 seconds. The user may start to play the voice message 1 or the voice message 2 by tapping a bubble 501 of the voice message 1 or a bubble 502 of the voice message 2. When detecting an operation of tapping the bubble 501 of the voice message 1 by the user, the mobile phone may send a play instruction for the voice message 1 to the headset in response to the operation. Correspondingly, the headset may receive the play instruction for the voice message 1 from the mobile phone, and play the voice message 1 at the initial volume level.

### 2. Adjust Volume

In this embodiment, after the headset starts the volume increase function when the first condition is met, the headset may increase a volume level of the headset when a second condition is met. Alternatively, after the headset starts the volume decrease function when the first condition is met, the headset may decrease a volume level of the headset when a second condition is met.

The second condition may include but is not limited to one or more of the following:

Detecting that duration of action force of the first push operation or the second push operation triggered by the user is greater than or equal to the first preset duration may be understood as that the user does not cancel the first push operation or the second push operation within the first preset duration after the user triggers the first push operation or the second push operation, or may be understood as that, within the first preset duration after the user triggers the first push operation or the second push operation, the headset detects action force continuously applied by the user to the headset based on the first push operation or the second push operation.

Alternatively, detecting that duration of action force of the first push operation or the second push operation triggered by the user is less than the first preset duration may be understood as that the user cancels the first push operation or the second push operation within the first preset duration after the user triggers the first push operation or the second push operation, or may be understood as that the headset does not detect action force continuously applied by the user to the headset based on the first push operation or the second push operation within the first preset duration after the user triggers the first push operation or the second push operation.

Alternatively, it is detected that the user triggers the second push operation, and duration of action force of the second push operation is less than the first preset duration.

Alternatively, it is detected that the user triggers a third push operation, and duration of action force of the third push operation is less than the first preset duration.

In some possible implementations, the push operation may include an operation that the user taps the headset, and a tapping part of the user keeps in contact with the headset after the tapping. It should be understood that the tapping part is usually a finger pad of a finger of the user. Certainly, a personal use habit of the user is not limited in each example, and the user may also push the headset by using a palm, to trigger the volume adjustment function. After the user taps the headset, a finger tapping the headset may maintain a contact relationship with a surface of the headset. In this process, action force applied to the headset based on an operation of tapping and contacting usually causes displacement of the headset. In this case, the headset may implement detection through cooperation between the capacitive sensor and the motion sensor.

In some possible implementation scenarios, the foregoing push operation is implemented by the user through a coherent gesture. The user taps the headset, and then holds the headset or presses the headset in a direction in which a finger swipes. In this way, the headset generates a specific degree of displacement relative to the head of the user. For the headset, the coherent gesture of the user may be detected through cooperation between the sensors in the foregoing example, to trigger the volume adjustment function of the headset.

For example, the headset may determine contact between the outside and the headset based on a capacitance change detected by the capacitive sensor. In addition, the headset may determine, based on a change of a parameter like an acceleration value, an angular velocity value, or magnetic field strength detected by the motion sensor, an external knock on the headset. It should be understood that, for a person skilled in the art, for a consumer electronic product like a headset, a weight of a same headset can be determined before the headset is sold. The weight of the headset may be considered as a constant. Action force applied by the user to the headset may be determined based on a parameter like the acceleration value detected by the motion sensor. In a process of processing a related parameter, the headset may convert the related parameter into force, or may not convert the related parameter. This processing process does not cause an insurmountable obstacle to implementation of the solutions in the examples. Therefore, the examples are not limited thereto.

Considering that different users have different operation habits, applied force may be large or small, and a degree of displacement of the headset may not be limited in each example. For example, a capacitance change threshold, an acceleration value change threshold, an angular velocity value change threshold, or a magnetic field change threshold may be adjusted to meet a gesture detection requirement.

In some examples, to facilitate the user to trigger the volume adjustment function of the headset, the headset may include one, two, or more control parts. For example, the front-end ball of the headset may be used as a control part of the headset, and the user may tap the front-end ball of the headset and keep contact with the front-end ball, to trigger the volume adjustment function of the headset. It should be understood that the control part may further include a partial region in which a cantilever arm is in contact with the front-end ball.

In some other examples, the rear-end ball of the headset may alternatively be used as a control part of the headset. The user may tap the rear-end ball of the headset and keep contact with the front-end ball, to trigger the volume adjustment function of the headset. It should be understood that the control part may further include a partial region in which the cantilever arm is in contact with the rear-end ball.

With reference to the foregoing two examples, the push operation on the front-end ball may be an operation of applying action force to the headset in the first direction. The push operation on the rear-end ball may be an operation of applying action force to the headset in the second direction. The first direction and the second direction may not need to meet a specific limitation condition that the first direction and the second direction are completely opposite to each other or an angle between the first direction and the second direction is less than a specific angle.

A person skilled in the art may configure a motion sensor to detect two substantially opposite directions, so as to implement a corresponding volume increase or volume decrease function.

For the user of the headset, for example, after the headset is worn, pushing the front-end ball of the headset backward may implement a volume increase function, and pushing the rear-end ball of the headset forward may implement a volume decrease function.

On the contrary, for example, after the headset is worn, pushing the front-end ball of the headset backward may implement a volume decrease function, and pushing the rear-end ball of the headset forward may implement a volume increase function.

In some other examples, the cantilever arm of the headset may alternatively be used as a control part. The user may tap the cantilever arm of the headset, and the headset is driven to generate displacement relative to the head of the user, to trigger the volume adjustment function of the headset. It should be understood that, considering that the cantilever arm is curved and is worn around the headset of the user, the operation on the cantilever arm may be a push operation in the first direction or the second direction.

In some examples, the push operation may further include an operation that the user touches the headset and pushes the headset after touching the headset. It should be understood that the contact process may be understood as a process in which the headset does not generate relative displacement, and detection may be implemented via the capacitive sensor. The pushing process may be a process of pressing the headset after contact and causing relative displacement of the headset. In this example, the push operation may be a coherent operation. Alternatively, the push operation may include two parts of operations of touching the headset and pausing for a while, and then pushing the headset. The push process mainly implements detection through cooperation between the motion sensor and the capacitive sensor.

In some possible implementation scenarios, for triggering of the volume adjustment function, the capacitive sensor may first detect that a capacitance change meets a capacitance change threshold, and then the motion sensor detects that a change of a related parameter meets a change threshold of this type of parameter. Alternatively, the motion sensor may first detect that a change of a related parameter meets a change threshold of this type of parameter, and then the capacitive sensor detects that a capacitance change meets a capacitance change threshold.

In some examples, if the user immediately releases the headset after tapping the headset, the operation may be considered as a tapping operation. For the headset, a tapping operation of the user may be detected through cooperation between the sensors in the foregoing example, to trigger the volume adjustment function of the headset. Alternatively, the tapping operation of the user is detected based on a related parameter obtained by the motion sensor.

In some other examples, the tapping operation may alternatively be defined as an operation of tapping the headset twice or a plurality of times by the user. Alternatively, the tapping operation may be defined as an operation of tapping a periphery of the ear twice.

In a common scenario in which the user performs an operation on the headset through a finger, the finger of the user is away from the control part after tapping the control part of the headset. The tapping operation may also be understood by analogy with a single tap operation, a double-tap operation, or a multi-tap operation on the touch sensor. An example of adjusting headset volume based on the tapping operation is also described below.

The following describes in detail a specific implementation of volume adjustment with reference to a specific example.

Example 1: The first condition may include: It is detected that the user triggers the first push operation; or it is detected that the user triggers the first push operation and then triggers the second push operation. The second condition may include: It is detected that the duration of the action force of the first push operation or the second push operation triggered by the user is greater than or equal to the first preset duration. When it is detected that the duration of the action force of the first push operation or the second push operation that is triggered by the user and that applies the action force to the headset in the first direction is greater than or equal to the first preset duration, the headset may adjust the volume level of the headset at an interval of one piece of preset duration. In addition, that volume corresponding to a volume unit after adjustment is greater than volume corresponding to a volume level before adjustment may be understood as that the headset gradually increases the volume level of the headset based on time. When it is detected that the duration of the action force of the first push operation or the second push operation that is triggered by the user and that applies the action force to the headset in the second direction is greater than or equal to the first preset duration, the headset may adjust the volume level of the headset at an interval of one piece of preset duration. In addition, that volume corresponding to a volume unit after adjustment is less than volume corresponding to a volume level before adjustment may be understood as that the headset gradually decreases the volume level of the headset based on time.

In a specific implementation process, the headset may adjust the volume level of the headset to a first volume level at a first moment. Duration between the first moment and a moment at which the headset starts the volume adjustment function is equal to second preset duration. The first volume level and the initial volume level are adjacent volume levels. When the headset gradually increases the volume level of the headset, volume corresponding to the first volume level is greater than volume corresponding to the initial volume level. When the headset gradually decreases the volume level of the headset, volume corresponding to the first volume level is less than volume corresponding to the initial volume level.

The headset may adjust the volume level of the headset to a second volume level at a second moment. The second moment is later than the first moment, and duration between the second moment and the first moment is equal to third preset duration. The second volume level and the first volume level are adjacent volume levels. When the headset gradually increases the volume level of the headset, volume corresponding to the second volume level is greater than volume corresponding to the first volume level. When the headset gradually decreases the volume level of the headset, volume corresponding to the second volume level is less than volume corresponding to the first volume level.

Optionally, the third preset duration may be less than or equal to the second preset duration. It may be understood as that preset duration (namely, the second preset duration) corresponding to initial volume adjustment is greater than or equal to preset duration (namely, the third preset duration) corresponding to non-initial volume adjustment. This reduces occurrence of an accidental touch of the user. Alternatively, the third preset duration may be greater than the second preset duration. It may be understood as that preset duration (namely, the second preset duration) corresponding to initial volume adjustment is less than preset duration (namely, the third preset duration) corresponding to non-initial volume adjustment. Therefore, sufficient time is reserved for the headset to detect the user operation for starting the volume adjustment function, to avoid a problem that user experience is poor because the user operation for starting the volume adjustment function is not detected. This is not specifically limited in embodiments of this application.

The rest may be deduced by analogy. The headset may adjust the volume level of the headset to an M^{th} volume level at a moment that is later than the second moment and that is at an interval of N pieces of third preset duration from the second moment, where N is a positive integer. The M^{th} volume level and the second volume level are separated by N volume levels. When the headset gradually increases the volume level of the headset, volume corresponding to the M^{th} volume level is greater than the volume corresponding to the second volume level. When the headset gradually decreases the volume level of the headset, volume corresponding to the M^{th} volume level is less than the volume corresponding to the second volume level.

In a possible implementation, the headset may further close the volume adjustment function when detecting that the user cancels the first push operation or the second push operation.

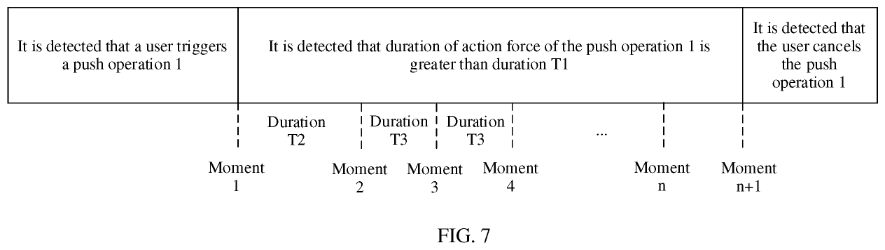

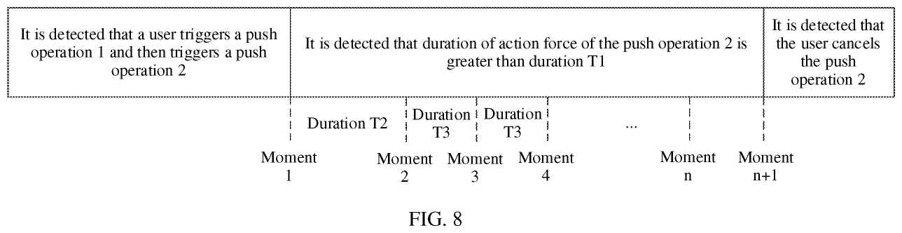

For example, FIG. 7 is a schematic flowchart of volume adjustment according to an embodiment of this application. As shown in FIG. 7, it is detected that the user triggers a push operation 1, and the headset starts a volume increase function or a volume decrease function at a moment 1. When it is detected that duration of action force of the push operation 1 is greater than duration T1, the headset adjusts a volume level of the headset from a volume level 1 to a volume level 2 at a moment 2, where duration between the moment 1 and the moment 2 is equal to one piece of duration T2, and the volume level 1 is an initial volume level of the headset; adjusts the volume level of the headset from the volume level 2 to a volume level 3 at a moment 3, where duration between the moment 3 and the moment 2 is equal to one piece of duration T3; and adjusts the volume level of the headset from the volume level 3 to a volume level 4 at a moment 4, where duration between the moment 4 and the moment 2 is equal to two pieces of duration T3. The rest may be deduced by analogy. The headset adjusts the volume level of the headset from a volume level n−1 to a volume level n at a moment n, where duration between the moment n and the moment 2 is equal to n−2 pieces of duration T3. Preset duration (namely, the duration T3) corresponding to initial volume adjustment is greater than preset duration (namely, the duration T2) corresponding to non-initial volume adjustment. Volume corresponding to the volume level 1, volume corresponding to the volume level 2, volume corresponding to the volume level 3, volume corresponding to the volume level 4, volume corresponding to the volume level n−1, and volume corresponding to the volume level n gradually increase or decrease. When it is detected that the user cancels the push operation 1, the headset closes the volume adjustment function at a moment n+1, that is, the moment n+1 is an end moment of the duration of the action force of the push operation 1.

For another example, FIG. 8 is another schematic flowchart of volume adjustment according to an embodiment of this application. As shown in FIG. 8, it is detected that the user triggers a push operation 2 after triggering a push operation, and the headset starts the volume increase function or the volume decrease function at a moment 1. When it is detected that duration of action force of the push operation 2 is greater than duration T1, the headset adjusts a volume level of the headset from a volume level 1 to a volume level 2 at a moment 2, where duration between the moment 1 and the moment 2 is equal to one piece of duration T2, and the volume level 1 is an initial volume level of the headset; adjusts the volume level of the headset from the volume level 2 to a volume level 3 at a moment 3, where duration between the moment 3 and the moment 2 is equal to one piece of duration T3; and adjusts the volume level of the headset from the volume level 3 to a volume level 4 at a moment 4, where duration between the moment 4 and the moment 2 is equal to two pieces of duration T3. The rest may be deduced by analogy. The headset adjusts the volume level of the headset from a volume level n−1 to a volume level n at a moment n, where duration between the moment n and the moment 2 is equal to n−2 pieces of duration T3. Preset duration (namely, the duration T3) corresponding to initial volume adjustment is greater than preset duration (namely, the duration T2) corresponding to non-initial volume adjustment. Volume corresponding to the volume level 1, volume corresponding to the volume level 2, volume corresponding to the volume level 3, volume corresponding to the volume level 4, volume corresponding to the volume level n−1, and volume corresponding to the volume level n gradually increase or decrease. When it is detected that the push operation 2 is canceled, the headset closes the volume adjustment function at a moment n+1, that is, the moment n+1 is an end moment of the duration of the action force of the push operation 2.

Example 2: The first condition may include: It is detected that the user triggers the first push operation; or it is detected that the user triggers the first push operation and then triggers the second push operation. The second condition may include: The duration of the action force of the first push operation or the second push operation triggered by the user is greater than or equal to the first preset duration. When it is detected that the duration of the action force of the first push operation or the second push operation that is triggered by the user and that applies the action force to the headset in the first direction is greater than or equal to the first preset duration, the headset may adjust the volume level of the headset once when detecting, within one piece of preset duration, one push operation triggered by the user. In addition, that volume corresponding to a volume unit after adjustment is greater than volume corresponding to a volume level before adjustment may be understood as that the headset gradually increases the volume level of the headset based on the push operation triggered by the user. When it is detected that the duration of the action force of the first push operation or the second push operation that is triggered by the user and that applies the action force to the headset in the second direction is greater than or equal to the first preset duration, the headset may adjust the volume level of the headset once when detecting, within one piece of preset duration, one push operation triggered by the user. In addition, that volume corresponding to a volume unit after adjustment is less than volume corresponding to a volume level before adjustment may be understood as that the headset gradually decreases the volume level of the headset based on the push operation triggered by the user.

In a specific implementation process, when the first condition includes that the user triggers the first push operation, and the second condition includes that the duration of the action force of the first push operation triggered by the user is greater than or equal to the first preset duration, the headset may detect that the user triggers the second push operation, and adjust the volume level of the headset to a third volume level. A moment at which it is detected that the user triggers the second push operation is a third moment, and duration between the third moment and the moment at which the volume adjustment function is started is less than or equal to fourth preset duration. The third volume level and the initial volume level are adjacent volume levels. When the headset gradually increases the volume level of the headset, volume corresponding to the third volume level is greater than the volume corresponding to the initial volume level. When the headset gradually decreases the volume level of the headset, volume corresponding to the third volume level is less than the volume corresponding to the initial volume level.

The headset may detect that the user triggers the third push operation, and adjust the volume level of the headset to a fourth volume level. A moment at which it is detected that the user triggers the third push operation is a fourth moment, and duration between the fourth moment and the third moment is less than or equal to fifth preset duration. The fourth volume level and the third volume level are adjacent volume levels. When the headset gradually increases the volume level of the headset, volume corresponding to the fourth volume level is greater than the volume corresponding to the third volume level. When the headset gradually decreases the volume level of the headset, volume corresponding to the fourth volume level is less than the volume corresponding to the third volume level.

Optionally, the fifth preset duration may be less than or equal to the fourth preset duration. It may be understood as that preset duration (namely, the fourth preset duration) corresponding to initial volume adjustment is greater than or equal to preset duration (namely, the fifth preset duration) corresponding to non-initial volume adjustment. This reduces occurrence of an accidental touch of the user. Alternatively, the fifth preset duration may be greater than the fourth preset duration. It may be understood as that preset duration (namely, the fourth preset duration) corresponding to initial volume adjustment is less than preset duration (namely, the fifth preset duration) corresponding to non-initial volume adjustment. Therefore, sufficient time is reserved for the headset to detect the user operation for starting the volume adjustment function, to avoid a problem that user experience is poor because the user operation for starting the volume adjustment function is not detected. This is not specifically limited in embodiments of this application.

In an implementation, the headset may further close the volume adjustment function when a fourth push operation triggered by the user is not detected within the fifth preset duration after the volume level of the headset is adjusted to the fourth volume level.

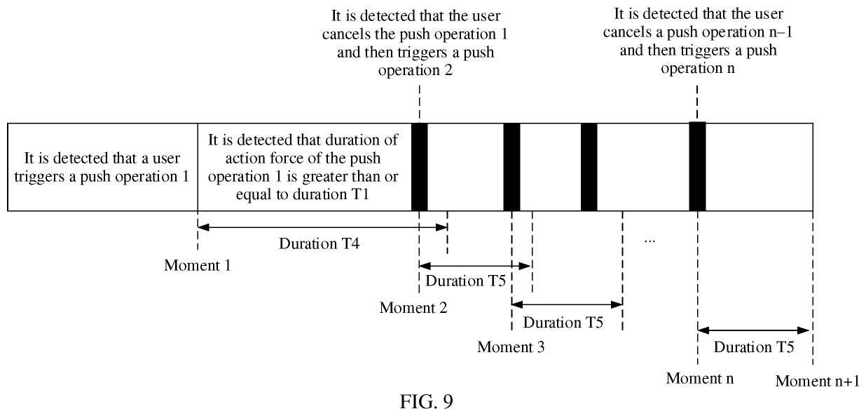

For example, FIG. 9 is still another schematic flowchart of volume adjustment according to an embodiment of this application. As shown in FIG. 9, it is detected that the user triggers a push operation 1, and the headset starts the volume increase function or the volume decrease function at a moment 1. When it is detected that duration of action force of the push operation 1 is greater than or equal to duration T1, the headset detects, at a moment 2, that the user triggers a push operation 2 after canceling the push operation 1, and adjusts the volume level of the headset from a volume level 1 to a volume level 2, where duration between the moment 1 and the moment 2 is less than or equal to one piece of duration T4, and the volume level 1 is an initial volume level of the headset; the headset detects, at a moment 3, that the user triggers a push operation 3 after canceling the push operation 2, and adjusts the volume level of the headset from the volume level 2 to a volume level 3, where duration between the moment 3 and the moment 2 is less than one piece of duration T5; and the headset detects, at a moment 4, that the user triggers a push operation 4 after canceling the push operation 3, and adjusts the volume level of the headset from the volume level 3 to a volume level 4, where duration between the moment 4 and the moment 3 is less than one piece of duration T5. The rest may be deduced by analogy. The headset detects, at a moment n, that the user triggers a push operation n after canceling a push operation n−1, and adjusts the volume level of the headset from a volume level n−1 to a volume level n, where duration between a moment n and a moment n−1 is less than one piece of duration T5. Preset duration (namely, the duration T4) corresponding to initial volume adjustment is greater than preset duration (namely, the duration T5) corresponding to non-initial volume adjustment. Volume corresponding to the volume level 1, volume corresponding to the volume level 2, volume corresponding to the volume level 3, volume corresponding to the volume level 4, volume corresponding to the volume level n−1, and volume corresponding to the volume level n gradually increase or decrease. If it is not detected, within one piece of duration T5 after the moment n, that the user triggers a push operation n+1 after canceling the push operation n, the headset closes the volume adjustment function at a moment n+1, where duration between the moment n+1 and the moment n is equal to one piece of duration T5.

Example 3: The first condition may include: It is detected that the user triggers the first push operation; or it is detected that the user triggers the first push operation and then triggers the second push operation. The second condition may include: It is detected that duration of action force of the first push operation or the second push operation triggered by the user is less than the first preset duration. When it is detected that the duration of the action force of the first push operation or the second push operation that is triggered by the user and that applies the action force to the headset in the first direction is less than the first preset duration, the headset may adjust the volume level of the headset once when detecting, within one piece of preset duration, one push operation triggered by the user. In addition, that volume corresponding to a volume unit after adjustment is greater than volume corresponding to a volume level before adjustment may be understood as that the headset gradually increases the volume level of the headset based on the push operation triggered by the user. When it is detected that the duration of the action force of the first push operation or the second push operation that is triggered by the user and that applies the action force to the headset in the second direction is less than the first preset duration, the headset may adjust the volume level of the headset once when detecting, within one piece of preset duration, one push operation triggered by the user. In addition, that volume corresponding to a volume unit after adjustment is less than volume corresponding to a volume level before adjustment may be understood as that the headset gradually decreases the volume level of the headset based on the push operation triggered by the user.

In a specific implementation process, when the first condition includes that the user triggers the first push operation, and the second condition includes that the duration of the action force of the first push operation triggered by the user is less than the first preset duration, the headset may adjust the volume level of the headset to a first volume level based on the first push operation. The first volume level and the initial volume level are adjacent volume levels. When the headset gradually increases the volume level of the headset, volume corresponding to the first volume level is greater than volume corresponding to the initial volume level. When the headset gradually decreases the volume level of the headset, volume corresponding to the first volume level is less than volume corresponding to the initial volume level.

The headset may detect that the user triggers the second push operation, and adjust the volume level of the headset to a second volume level. A moment at which the volume level of the headset is adjusted to the first volume level is a first moment, a moment at which it is detected that the user triggers the second push operation is a second moment, and duration between the first moment and the second moment is first duration. A sum of the first duration and the duration of the action force of the second push operation is less than or equal to second preset duration. The second volume level and the first volume level are adjacent volume levels. When the headset gradually increases the volume level of the headset, volume corresponding to the second volume level is greater than volume corresponding to the first volume level. When the headset gradually decreases the volume level of the headset, volume corresponding to the second volume level is less than volume corresponding to the first volume level.

Optionally, the second preset duration may be less than or equal to the first preset duration. It may be understood as that preset duration (namely, the first preset duration) corresponding to initial volume adjustment is greater than or equal to preset duration (namely, the second preset duration) corresponding to non-initial volume adjustment. This reduces occurrence of an accidental touch of the user. Alternatively, the second preset duration may be greater than the first preset duration. It may be understood as that preset duration (namely, the first preset duration) corresponding to initial volume adjustment is less than preset duration (namely, the second preset duration) corresponding to non-initial volume adjustment. Therefore, sufficient time is reserved for the headset to detect the user operation for starting the volume adjustment function, to avoid a problem that user experience is poor because the user operation for starting the volume adjustment function is not detected. This is not specifically limited in embodiments of this disclosure.

In an implementation, the headset may further close the volume adjustment function when a third push operation triggered by the user is not detected within the second preset duration after the volume level of the headset is adjusted to the second volume level. Alternatively, the headset closes the volume adjustment function when action force continuously applied by the user to the headset based on the third push operation is detected within the second preset duration after the volume level of the headset is adjusted to the second volume level.

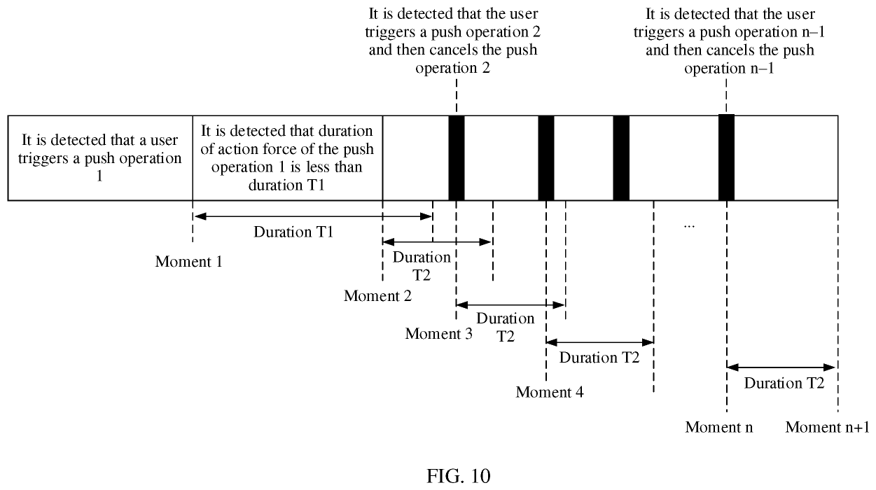

For example, FIG. 10 is yet another schematic flowchart of volume adjustment according to an embodiment. As shown in FIG. 10, it is detected that the user triggers a push operation 1, and the headset starts the volume increase function or the volume decrease function at a moment 1. The headset detects, at a moment 2, that the user cancels the push operation 1, and adjusts the volume level of the headset from a volume level 1 to a volume level 2, where duration between the moment 1 and the moment 2 is less than one piece of duration T1, that is, duration of action force of the push operation 1 is less than the duration T1, and the volume level 1 is an initial volume level of the headset; the headset detects, at a moment 3, that the user triggers a push operation 2 and then cancels the push operation 2, and adjusts the volume level of the headset from the volume level 2 to a volume level 3, where duration between the moment 3 and the moment 2 is less than one piece of duration T2; and the headset detects, at a moment 4, that the user triggers a push operation 3 and then cancels the push operation 3, and adjusts the volume level of the headset from the volume level 3 to a volume level 4, where duration between the moment 4 and the moment 3 is less than one piece of duration T2. The rest may be deduced by analogy. The headset detects, at a moment n, that the user triggers a push operation n−1 and then cancels the push operation n−1, and adjusts the volume level of the headset from a volume level n−1 to a volume level n, where duration between a moment n and a moment n−1 is less than one piece of duration T2. Preset duration (namely, the duration T1) corresponding to initial volume adjustment is greater than preset duration (namely, the duration T2) corresponding to non-initial volume adjustment. Volume corresponding to the volume level 1, volume corresponding to the volume level 2, volume corresponding to the volume level 3, volume corresponding to the volume level 4, volume corresponding to the volume level n−1, and volume corresponding to the volume level n gradually increase or decrease. If it is not detected, within one piece of duration T2 after the moment n, that the user triggers a push operation n and then cancels the push operation n (for example, the push operation n is not triggered, or the push operation n is not canceled after the push operation n is triggered), the headset closes the volume adjustment function at a moment n+1, where duration between the moment n+1 and the moment n is equal to one piece of duration T2.

Example 4: The first condition may include: It is detected that the user triggers the first push operation, and duration of action force of the first push operation is less than the first preset duration. The second condition may include: It is detected that the user triggers the second push operation, and duration of action force of the second push operation is less than the first preset duration.

When it is detected that the duration of the action force of the first push operation that is triggered by the user and that applies the action force to the headset in the first direction is less than the first preset duration, the headset may adjust the volume level of the headset once when detecting, within one piece of preset duration, one push operation triggered by the user. In addition, that volume corresponding to a volume unit after adjustment is greater than volume corresponding to a volume level before adjustment may be understood as that the headset gradually increases the volume level of the headset based on the push operation triggered by the user. When it is detected that the duration of the action force of the first push operation that is triggered by the user and that applies the action force to the headset in the second direction is less than the first preset duration, the headset may adjust the volume level of the headset once when detecting, within one piece of preset duration, one push operation triggered by the user. In addition, that volume corresponding to a volume unit after adjustment is less than volume corresponding to a volume level before adjustment may be understood as that the headset gradually decreases the volume level of the headset based on the push operation triggered by the user.

In a specific implementation process, the headset may detect that the user triggers the second push operation, and adjust the volume level of the headset to the first volume level. A moment at which it is detected that the user triggers the second push operation is a first moment, duration between the first moment and a moment at which the volume adjustment function is started is first duration, and a sum of the first duration and the duration of the action force of the second push operation is less than or equal to second preset duration. The first volume level and the initial volume level are adjacent volume levels. When the headset gradually increases the volume level of the headset, volume corresponding to the first volume level is greater than volume corresponding to the initial volume level. When the headset gradually decreases the volume level of the headset, volume corresponding to the first volume level is less than volume corresponding to the initial volume level.

The headset may detect that the user triggers a third push operation, and adjust the volume level of the headset to a second volume level. A moment at which it is detected that the user triggers the third push operation is a second moment, duration between the second moment and a moment at which the volume level of the headset is adjusted to the first volume level is second duration, and a sum of the second duration and duration of action force of the third push operation is less than or equal to third preset duration. The second volume level and the first volume level are adjacent volume levels. When the headset gradually increases the volume level of the headset, volume corresponding to the second volume level is greater than volume corresponding to the first volume level. When the headset gradually decreases the volume level of the headset, volume corresponding to the second volume level is less than volume corresponding to the first volume level.

Optionally, the third preset duration may be less than or equal to the second preset duration. It may be understood as that preset duration (namely, the second preset duration) corresponding to initial volume adjustment is greater than or equal to preset duration (namely, the third preset duration) corresponding to non-initial volume adjustment. This reduces occurrence of an accidental touch of the user. Alternatively, the third preset duration may be greater than the second preset duration. It may be understood as that preset duration (namely, the second preset duration) corresponding to initial volume adjustment is less than preset duration (namely, the third preset duration) corresponding to non-initial volume adjustment. Therefore, sufficient time is reserved for the headset to detect the user operation for starting the volume adjustment function, to avoid a problem that user experience is poor because the user operation for starting the volume adjustment function is not detected. This is not specifically limited in embodiments of this application.

In an implementation, the headset may further close the volume adjustment function when a fourth push operation triggered by the user is not detected within the third preset duration after the volume level of the headset is adjusted to the second volume level. Alternatively, the headset closes the volume adjustment function when action force continuously applied by the user to the headset based on the fourth push operation is detected within the third preset duration after the volume level of the headset is adjusted to the second volume level.

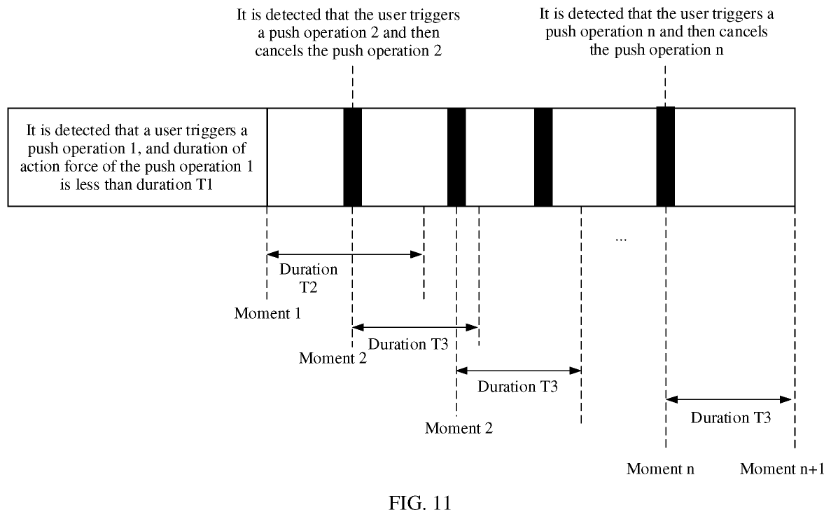

For example, FIG. 11 is still yet another schematic flowchart of volume adjustment according to an embodiment. As shown in FIG. 11, it is detected that a push operation 1 is triggered and duration of action force of the push operation 1 is less than duration T1, and the headset starts the volume increase function or the volume decrease function at a moment 1. The headset detects, at a moment 2, that the user triggers a push operation 2 and then cancels the push operation 2, and adjusts the volume level of the headset from a volume level 1 to a volume level 2, where duration between the moment 1 and the moment 2 is less than one piece of duration T2, and the volume level 1 is an initial volume level of the headset; the headset detects, at a moment 3, that the user triggers a push operation 3 and then cancels the push operation 3, and adjusts the volume level of the headset from the volume level 2 to a volume level 3, where duration between the moment 3 and the moment 2 is less than one piece of duration T3; and the headset detects, at a moment 4, that the user triggers a push operation 4 and then cancels the push operation 4, and adjusts the volume level of the headset from the volume level 3 to a volume level 4, where duration between the moment 4 and the moment 3 is less than one piece of duration T3. The rest may be deduced by analogy. The headset detects, at a moment n, that the user triggers a push operation n and then cancels the push operation n, and adjusts the volume level of the headset from a volume level n−1 to a volume level n, where duration between a moment n and a moment n−1 is less than one piece of duration T3. Preset duration (namely, the duration T2) corresponding to initial volume adjustment is greater than preset duration (namely, the duration T3) corresponding to non-initial volume adjustment. Volume corresponding to the volume level 1, volume corresponding to the volume level 2, volume corresponding to the volume level 3, volume corresponding to the volume level 4, volume corresponding to the volume level n−1, and volume corresponding to the volume level n gradually increase or decrease. If it is not detected, within one piece of duration T3 after the moment n, that the user triggers a push operation n+1 and then cancels the push operation n+1 (for example, the push operation n+1 is not triggered, or the push operation n+1 is not canceled after the push operation n+1 is triggered), the headset closes the volume adjustment function at a moment n+1, where duration between the moment n+1 and the moment n is equal to one piece of duration T3.

Example 5: The first condition may include: It is detected that the user triggers the first push operation and then triggers the second push operation, and duration of action force of the second push operation is less than the first preset duration. The second condition may include: It is detected that the user triggers the third push operation, and duration of action force of the third push operation is less than the first preset duration. For details of “Example 5”, refer to the descriptions in “Example 4”. Details are not described herein again.

In a possible implementation, after starting the volume adjustment function, the headset may set duration of the volume adjustment function, or may set a quantity of volume adjustment times, to avoid a problem that user experience is poor because a user operation of closing the volume adjustment function is not detected. For example, the headset may set duration between a moment at which the volume adjustment function is started and a moment at which the volume adjustment function is closed to be less than or equal to a first threshold; or the headset may set a quantity of times of adjusting the volume level of the headset to be less than or equal to a second threshold. It should be understood that the first threshold and the second threshold may be default values, or may be values set by the user as required. This is not specifically limited in embodiments of this application.

In a possible implementation, the headset may determine, based on first volume and second volume, a difference between volume corresponding to adjacent volume levels, for example, a difference between volume corresponding to the volume level 1 and volume corresponding to the volume level 2, or a difference between volume corresponding to the volume level 3 and volume corresponding to the volume level 4. The first volume is volume (namely, volume corresponding to an initial volume level) of the headset at a moment at which the volume adjustment function is started, the second volume is obtained by the headset based on ambient volume and/or historical volume, and the historical volume is volume determined by the user in previous volume adjustment.

In a specific implementation process, an example in which the headset increases the volume level of the headset is used. When the first volume is greater than or equal to the second volume, the headset may determine that a difference between volume corresponding to adjacent volume levels is a third threshold. The third threshold is a minimum volume adjustment value supported by the headset. Alternatively, when the first volume is less than the second volume, and a difference between the first volume and the second volume is less than a fourth threshold, the headset may determine that the difference between volume corresponding to adjacent volume levels is the difference between the first volume and the second volume. The fourth threshold is a maximum volume adjustment value supported by the headset. Alternatively, when the first volume is less than the second volume, and a difference between the first volume and the second volume is greater than or equal to the fourth threshold, the headset may determine that the difference between volume corresponding to adjacent volume levels is the fourth threshold. It should be understood that the difference between the first volume and the second volume is an absolute value.

For example, the headset may adjust the volume level of the headset according to the following formula, to gradually increase the volume of the headset:

$$change\_volume = \{ \begin{matrix}td while cv \geq pv \\ pv - cv while cv < pv and pv - cv < tm \\ tm while cv < pv and pc - cv \geq tm\end{matrix}$$

change_volume is a difference between volume corresponding to adjacent volume levels, cv is first volume, pv is second volume, td is a minimum volume adjustment value supported by the headset, and tm is a maximum volume adjustment value supported by the headset.

For example, the headset adjusts the volume level of the headset to gradually decrease the volume of the headset. When the first volume is less than or equal to the second volume, the headset may determine that the difference between volume corresponding to adjacent volume levels is the third threshold. The third threshold is a minimum volume adjustment value supported by the headset. Alternatively, when the first volume is greater than the second volume, and a difference between the first volume and the second volume is less than a fourth threshold, the headset may determine that the difference between volume corresponding to adjacent volume levels is the difference between the first volume and the second volume. The fourth threshold is a maximum volume adjustment value supported by the headset. Alternatively, when the first volume is greater than the second volume, and a difference between the first volume and the second volume is greater than or equal to the fourth threshold, the headset may determine that the difference between volume corresponding to adjacent volume levels is the fourth threshold. The difference between the first volume and the second volume is an absolute value.

For example, the headset may adjust the volume level of the headset according to the following formula, to gradually decrease the volume of the headset:

$$change\_volume = \{ \begin{matrix}- td while cv \leq pv \\ pv - cv while cv > pv and pv - cv > tm \\ tm while cv > pv and pc - cv \leq tm\end{matrix}$$

change_volume is a difference between volume corresponding to adjacent volume levels, cv is first volume, pv is second volume, td is a minimum volume adjustment value supported by the headset, and tm is a maximum volume adjustment value supported by the headset.

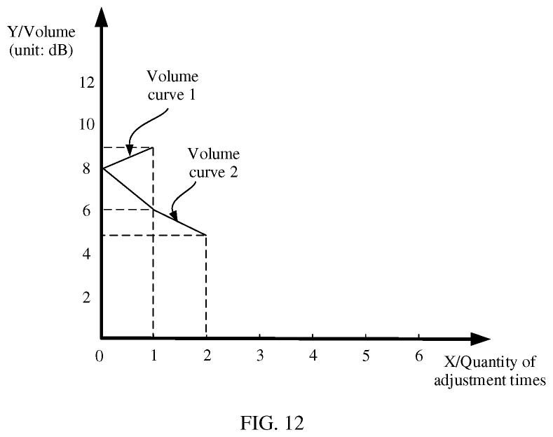

For another example, the headset may adjust the volume level of the headset based on a curve shown in FIG. 12. The first volume cv is equal to 8, the minimum volume adjustment value td supported by the headset is equal to 1, the maximum volume adjustment value tm supported by the headset is equal to 3, and the second volume pv is equal to 6. When the volume of the headset is increased from the first volume to the volume corresponding to the volume level 1, the volume corresponding to the volume level 1 is 9, that is, a difference between the volume corresponding to the volume level 1 and the first volume is td=1. When the volume of the headset is decreased from the first volume to the volume corresponding to the volume level 1, the volume corresponding to the volume level 1 is 6, that is, a difference between the volume corresponding to the volume level 1 and the first volume is cv−pv=2. When the volume of the headset is decreased from the volume corresponding to the volume level 1 to the volume corresponding to the volume level 2, the volume corresponding to the volume level 2 is 5, that is, a difference between the volume corresponding to the volume level 2 and the volume corresponding to the volume level 1 is td=1.

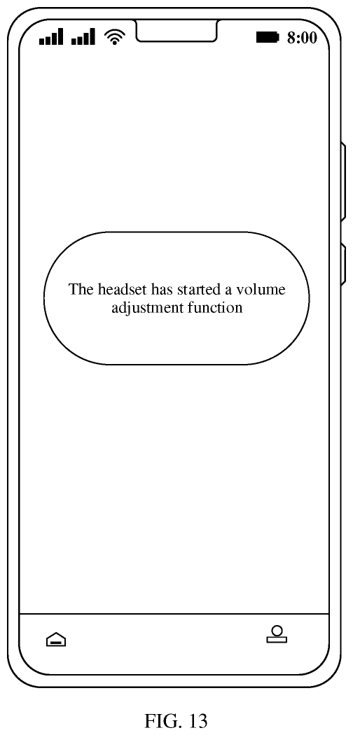

In an optional implementation, when the headset starts the volume adjustment function, adjusts the volume level of the headset, and closes the volume adjustment function, the headset may feed back a current status of the headset to the user by playing audio. For example, when the headset starts the volume adjustment function, the headset may play audio of “DiDiDi”. Alternatively, the headset may further synchronize a current status of the headset to an electronic device, and feed back the current status of the headset to the user via the electronic device. For example, when the headset starts the volume adjustment function, the electronic device may display, on a display, an interface shown in FIG. 13. The interface displays information used to prompt the user that the headset has started the volume adjustment function, for example, “The headset has started the volume adjustment function”. For another example, when the headset starts the volume adjustment function, the electronic device may vibrate once to notify the user that the headset has started the volume adjustment function.

In an optional implementation, if the headset is the headset 100A clamped on the auricle shown in (1) in FIG. 3, the headset may start the volume adjustment function when a third condition is met. A rotation operation may be an operation of rotating the cantilever arm of the headset in a third direction or a fourth direction. The third condition may include: It is detected that the user triggers a first rotation operation. The volume adjustment function may include a volume increase function and a volume decrease function. That the volume increase function corresponds to the third direction may be understood as that when the rotation operation is an operation of rotating the cantilever arm of the headset in the third direction, the volume adjustment function started by the headset when the third condition corresponding to the rotation operation is met is the volume increase function. That the volume decrease function corresponds to the fourth direction may be understood as that when the rotation operation is an operation of rotating the cantilever arm of the headset in the fourth direction, the volume adjustment function started by the headset when the third condition corresponding to the rotation operation is met is the volume decrease function. The headset may adjust the volume level of the headset when a fourth condition is met. The fourth condition may include: It is detected that the user triggers a second rotation operation and then triggers a third rotation operation. A direction corresponding to the second rotation operation is opposite to a direction corresponding to the first rotation operation. A direction corresponding to the third rotation operation is the same as the direction corresponding to the first rotation operation. During specific implementation, the headset may detect a user operation by collecting data of each sensor (for example, a motion sensor) of the headset.

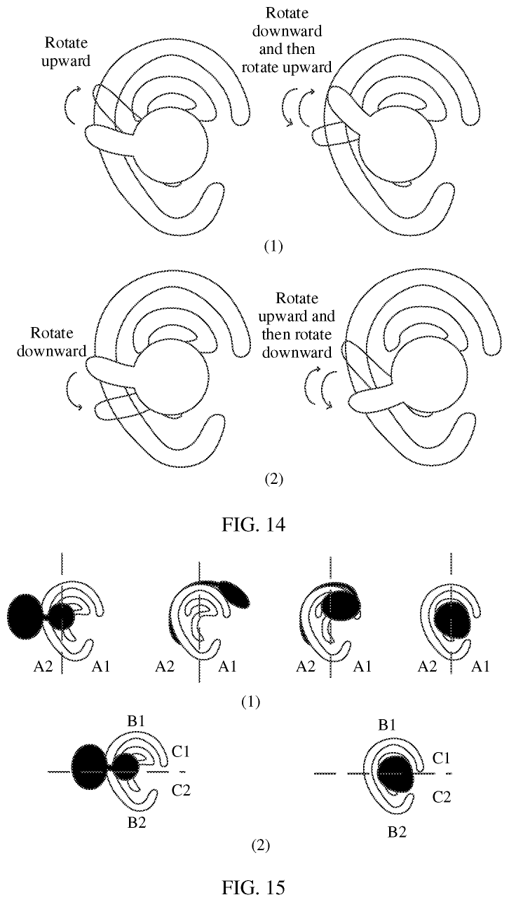

For example, FIG. 14 is a diagram of a volume adjustment scenario according to an embodiment of this application. For example, the headset is the headset 100A shown in (1) in FIG. 3. As shown in (1) in FIG. 14, the user may rotate the cantilever arm of the headset 100A upward to start the volume increase function, and the user may increase the volume of the headset by rotating the cantilever arm of the headset 100A downward and then rotating the cantilever arm of the headset 100A upward. As shown in (2) in FIG. 14, the user may rotate the cantilever arm of the headset 100A downward to start the volume decrease function, and the user may decrease the volume of the headset by rotating the cantilever arm of the headset 100A upward and then rotating the cantilever arm of the headset 100A downward.

In an optional implementation, the headset may start the volume adjustment function when a fifth condition is met. A tapping operation may alternatively be an operation of tapping a first region or a second region of the periphery of the ear twice. The fifth condition may include: It is detected that the user triggers the tapping operation. The volume adjustment function may include a volume increase function and a volume decrease function. That the volume increase function corresponds to the first region may be understood as that when the tapping operation is an operation of tapping the first region of the periphery of the ear twice, the volume adjustment function started by the headset when the fifth condition corresponding to the tapping operation is met is the volume increase function. The volume decrease function corresponds to the second region. It may be understood as that when the tapping operation is an operation of tapping the second region of the periphery of the ear twice, the volume adjustment function started by the headset when the fifth condition corresponding to the tapping operation is met is the volume decrease function. The headset may adjust the volume level of the headset when a sixth condition is met. The sixth condition may include: It is detected that the user triggers the tapping operation. During specific implementation, the headset may detect the user operation by collecting data of each sensor (for example, a bone conduction sensor) of the headset.

For example, FIG. 15 is a diagram of another volume adjustment scenario according to an embodiment of this application. As shown in (1) in FIG. 15, a headset is divided into two regions: a region A1 and a region A2 by using a concha cavity as a center and a vertical direction as a boundary. The user may tap the region A1 twice to start the volume increase function, and the user may tap the region A1 twice to increase the volume of the headset. The user may tap the region A2 twice to start the volume decrease function, and the user may tap the region A2 twice to decrease the volume of the headset.

As shown in (2) in FIG. 15, the headset is divided into an upper region and a lower region: a region B1 and C1 and a region B2 and C2 by using a concha cavity as a center and a horizontal direction as a boundary. The user may tap the region B1 or the region C1 twice to start the volume increase function, and the user may tap the region B1 or the region C1 twice to increase the volume of the headset. The user may tap the region B2 or the region C2 twice to start the volume decrease function, and the user may tap the region B2 or the region C2 twice to decrease the volume of the headset.

According to the foregoing solution, the headset may start volume adjustment when a preset first condition is met (for example, it is detected that the user triggers the first push operation). This improves a volume adjustment manner. The first push operation involves a small quantity of interaction contacts. This resolves a problem in the conventional technology that volume cannot be adjusted because the headset has a small quantity of interaction contacts. In addition, in this embodiment of this application, the headset may adaptively adjust the volume level of the headset (for example, based on preset duration or a preset operation) when a preset second condition is met. This improves volume adjustment efficiency.

In Embodiment 2, an example in which the headset control method provided in this embodiment of this application is used to switch audio played by the headset is used. An execution process of switching audio played by the headset includes at least three phases: starting audio playing, starting audio switching, and audio switching. The following describes in detail the method in each phase.

### 1. Start Audio Playing

In this embodiment, for details, refer to related content of “playing the first audio at the initial volume level” in “1. Start volume adjustment” in Embodiment 1. Details are not described herein again.

### 2. Start Audio Switching

In this embodiment, after the headset plays the first audio at the initial volume level, if the first audio is switchable audio, the headset may start an audio switching function when a first condition is met.

A push operation is an operation of applying action force to the headset in a first direction or a second direction, and the first condition may include but is not limited to one or more of the following:

Detecting that a user triggers a first push operation may be understood as that the user does not cancel the first push operation after triggering the first push operation. For example, the user pushes a rear-end ball of the headset forward (pushes), that is, the rear-end ball remains in a pushed state after the user performs one push operation on the headset.

Alternatively, detecting that the user triggers a first push operation and duration of action force of the first push operation is less than first preset duration may be understood as that the user cancels the first push operation after triggering the first push operation. For example, the user pushes the rear-end ball of the headset forward, and then releases the rear-end ball of the headset (that is, pushes and releases), that is, the rear-end ball remains in a released state after the user performs one push operation on the headset.

Alternatively, detecting that the user triggers a first push operation and then triggers a second push operation may be understood as that the user triggers the first push operation and then cancels the first push operation, and then triggers the second push operation. For example, the user pushes a rear-end ball of the headset forward, releases the rear-end ball of the headset, and pushes the rear-end ball of the headset forward again (pushes, releases, and pushes), that is, the rear-end ball remains in a pushed state after the user performs two push operations on the headset.

Alternatively, detecting that the user triggers a first push operation and then triggers a second push operation, and duration of action force of the second push operation is less than first preset duration may be understood as that the user triggers the first push operation and then cancels the first push operation, and triggers the second push operation and then cancels the second push operation. For example, the user pushes a rear-end ball of the headset forward, releases the rear-end ball of the headset, pushes the rear-end ball of the headset forward again, and releases the rear-end ball of the headset again (pushes, releases, pushes, and releases), that is, the rear-end ball remains in a released state after the user performs two push operations on the headset.

The audio switching function may include an audio switching function of switching to previous audio or an audio switching function of switching to next audio. That the audio switching function of switching to previous audio corresponds to a first direction may be understood as that when a push operation is an operation of applying action force to the headset in the first direction, the audio switching function started by the headset when the first condition corresponding to the push operation is met is the audio switching function of switching to previous audio. That the audio switching function of switching to next audio corresponds to a second direction may be understood as that when a push operation is an operation of applying action force to the headset in the second direction, the audio switching function started by the headset when the first condition corresponding to the push operation is met is the audio switching function of switching to next audio.

It should be understood that switching to previous audio or switching to next audio in this embodiment of this application may be switching from playing the first audio at the initial volume level to playing second audio or third audio at a first volume level, where the second audio is previous audio of the first audio, and the third audio is next audio of the first audio; or may be switching from playing the first audio at the initial volume level to preparing to play second audio or third audio at a first volume level. It may be understood as that the second audio or the third audio is not played after the second audio or the third audio is switched to. Instead, the second audio or the third audio is played after the audio switching function is closed.

For example, a current playlist of a music application includes a song 1, a song 2, and a song 3, and the headset plays the song 2 at the first volume level. When the first condition is met, the headset may start an audio switching function of switching to the song 1 or the song 3.

During specific implementation, the headset may detect a user operation by collecting data of each sensor (for example, a capacitive sensor, a motion sensor, or a bone conduction sensor) of the headset.

### 3. Switch Audio

After the headset starts, when the first condition is met, the audio switching function of switching to previous audio, the headset may switch to the previous audio when a second condition is met. Alternatively, after the headset starts, when the first condition is met, the audio switching function of switching to next audio, the headset may switch to the next audio when a second condition is met.

The second condition may include but is not limited to one or more of the following:

Detecting that duration of action force of the first push operation or the second push operation triggered by the user is greater than or equal to the first preset duration may be understood as that the user does not cancel the first push operation or the second push operation within the first preset duration after the user triggers the first push operation or the second push operation, or may be understood as that, within the first preset duration after the user triggers the first push operation or the second push operation, the headset detects action force continuously applied by the user to the headset based on the first push operation or the second push operation.

Alternatively, detecting that duration of action force of the first push operation or the second push operation triggered by the user is less than the first preset duration may be understood as that the user cancels the first push operation or the second push operation within the first preset duration after the user triggers the first push operation or the second push operation, or may be understood as that the headset does not detect action force continuously applied by the user to the headset based on the first push operation or the second push operation within the first preset duration after the user triggers the first push operation or the second push operation.

Alternatively, it is detected that the user triggers the second push operation, and duration of action force of the second push operation is less than the first preset duration.

Alternatively, it is detected that the user triggers a third push operation, and duration of action force of the third push operation is less than the first preset duration.

It should be understood that, for specific implementation of switching to previous audio or switching to next audio by the headset, refer to related content in “2. Adjust volume” in Embodiment 1. Details are not described herein again.

Based on the foregoing embodiments and a same concept, this application further provides a headset control method. The method may be performed by the headset shown in FIG. 1 and FIG. 2.

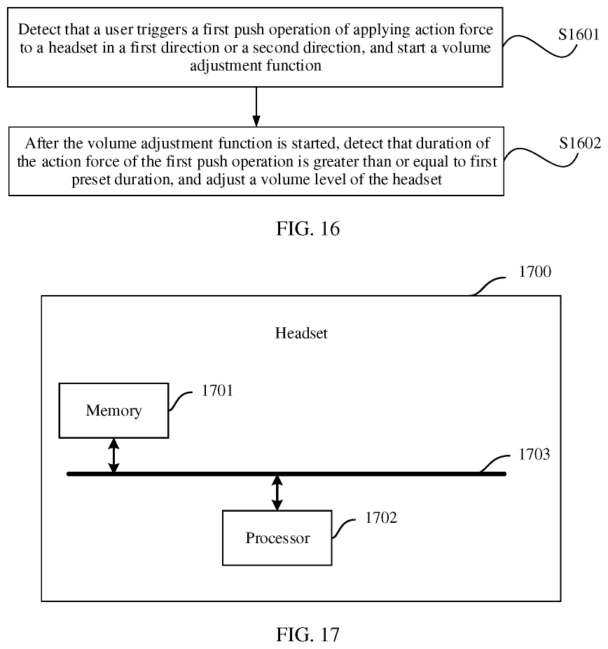

FIG. 16 is a schematic flowchart of a headset control method according to an embodiment of this application. With reference to FIG. 16, the method includes the following steps.
S1601: Detect that a user triggers a first push operation of applying action force to a headset in a first direction or a second direction, and start a volume adjustment function.

The first direction corresponds to a volume increase function in the volume adjustment function, and the second direction corresponds to a volume decrease function in the volume adjustment function. For details of S1601, refer to descriptions in “1. Start volume adjustment”. Details are not described herein again.
S1602: After the volume adjustment function is started, detect that duration of the action force of the first push operation is greater than or equal to first preset duration, and adjust a volume level of the headset.

For details of S1602, refer to descriptions in “2. Adjust volume”. Details are not described herein again.

It should be noted that the specific implementation procedures provided in the foregoing examples are merely examples of the method procedures applicable to embodiments of this application. An execution sequence of the steps may be correspondingly adjusted based on an actual requirement, and another step may be added, or some steps may be removed.

Based on the foregoing embodiments and a same concept, an embodiment of this application further provides a headset. The headset is configured to implement the method performed by the headset provided in embodiments of this application.

As shown in FIG. 17, the headset 1700 may include a memory 1701, one or more processors 1702, and one or more computer programs (not shown in the figure). The foregoing components may be coupled through one or more communication buses 1703.

The memory 1701 stores one or more computer programs (code), and the one or more computer programs include computer instructions. The one or more processors 1702 invoke the computer instructions stored in the memory 1701, so that the headset 1700 performs the headset control method provided in embodiments of this disclosure.

During specific implementation, the memory 1701 may include a high-speed random access memory, and may also include a nonvolatile memory like one or more magnetic disk storage devices, a flash device, or another nonvolatile solid-state storage device. The memory 1701 may store an operating system (referred to as a system below), for example, an embedded operating system like Android, iOS, Windows, or Linux. The memory 1701 may be configured to store an implementation program of this embodiment. The memory 1701 may further store a network communication program. The network communication program may be used to communicate with one or more auxiliary devices, one or more user equipments, and one or more network devices. The one or more processors 1702 may be a general-purpose central processing unit (CPU), a microprocessor, an application-specific integrated circuit (ASIC), or one or more integrated circuits configured to control program execution of the solutions of this application.

It should be noted that FIG. 17 is merely an implementation of the headset 1700 according to this embodiment. In actual application, the headset 1700 may further include more or fewer components. This is not limited herein.

Based on the foregoing embodiments and a same concept, an embodiment provides a computer-readable storage medium that stores a computer program. When the computer program runs on a computer, the computer is enabled to perform the method performed by the headset in the methods that are provided in the foregoing embodiments.

Based on the foregoing embodiments and a same concept, an embodiment of this disclosure provides a computer program product. The computer program product includes a computer program or instructions. When the computer program or the instructions are run on a computer, the computer is enabled to perform the method performed by the headset in the methods that are provided in the foregoing embodiments.

A person skilled in the art should understand that any of the disclosed embodiments may be provided as a method, a system, or a computer program product. Therefore, this disclosure may use a form of hardware only embodiments, software only embodiments, or embodiments with a combination of software and hardware. In addition, any of the disclosed embodiments may use a form of a computer program product that is implemented on one or more computer-usable storage media (including but not limited to a disk memory, a CD-ROM, an optical memory, and the like) that include computer-usable program code.

Disclosed embodiments are described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is to be appreciated that a person skilled in the art may, following review of this disclosure, make various modifications and variations to any of the disclosed embodiments without departing from the spirit and scope of this disclosure. Any such modifications or variations are intended to be covered to the extent that they fall within the scope of protection afforded by the accompanying claims.

What is claimed is:

1. A control method applied to a headset, the method comprising:
detecting a first push operation of applying action force to the headset in a first direction or a second direction, and starting a volume adjustment function, wherein the first direction corresponds to a volume increase function in the volume adjustment function, and the second direction corresponds to a volume decrease function in the volume adjustment function; and
detecting that duration of the action force of the first push operation is greater than or equal to first preset duration, and adjusting a volume level of the headset in accordance with the duration of the first push operation.

2. The method according to claim 1, wherein the adjusting the volume level of the headset comprises:
adjusting the volume level of the headset to a first volume level at a first moment; and
adjusting the volume level of the headset to a second volume level at a second moment, wherein the second moment is later than the first moment.

3. The method according to claim 2, wherein duration between the first moment and a moment at which the volume adjustment function is started is equal to second preset duration, and duration between the second moment and the first moment is equal to third preset duration.

4. The method according to claim 2, further comprising:
detecting cancelation of the first push operation on the headset, and closing the volume adjustment function.

5. The method according to claim 1, wherein the adjusting the volume level of the headset comprises:
detecting a second push operation on the headset, and adjusting the volume level of the headset to a third volume level in accordance with the second push operation; and
detecting a third push operation on the headset, and adjusting the volume level of the headset to a fourth volume level in accordance with the third push operation.

6. The method according to claim 5, wherein a moment at which the second push operation on the headset is detected is a third moment, duration between the third moment and a moment at which the volume adjustment function is started is less than or equal to a fourth preset duration, a moment at which the third push operation on the headset is detected is a fourth moment, and duration between the fourth moment and the third moment is less than or equal to a fifth preset duration as measured from time of activation of the headset to initial adjustment of volume.

7. The method according to claim 6, further comprising:
detecting absence of a fourth push operation on the headset within the fifth preset duration after the volume level of the headset is adjusted to the fourth volume level; and
closing the volume adjustment function.

8. The method according to claim 1, wherein duration between the moment at which the volume adjustment function is started and a moment at which the volume adjustment function is closed is less than or equal to a first threshold; or
a quantity of times of adjusting the volume level of the headset is less than or equal to a second threshold.

9. The method according to claim 1, wherein detecting the first push operation comprises detecting an operation of receipt at a control part of the headset a tapping motion and continuation of contact with the control part after the tapping, the control part comprises a front-end ball or a rear-end ball of the headset, and the front-end ball is connected to the rear-end ball via a curved cantilever arm.

10. The method according to claim 1, wherein detecting the first push operation comprises detecting an operation of receipt at a control part of the headset a tapping motion and an operation of pushing the control part, the control part comprises a front-end ball or a rear-end ball of the headset, and the front-end ball is connected to the rear-end ball via a curved cantilever arm.

11. A headset control method, comprising:
detecting a first push operation of applying action force to the headset in a first direction or a second direction, and starting a volume adjustment function, wherein the first direction corresponds to a volume increase function in the volume adjustment function, and the second direction corresponds to a volume decrease function in the volume adjustment function; and
detecting that duration of the action force of the first push operation is less than first preset duration, and adjusting a volume level of the headset.

12. The method according to claim 11, wherein adjusting the volume level of the headset comprises:
adjusting the volume level of the headset to a first volume level based on the first push operation; and
detecting a second push operation on the headset and adjusting the volume level of the headset to a second volume level.

13. The method according to claim 12, wherein:
a moment at which the volume level of the headset is adjusted to the first volume level is a first moment;
a moment at which the second push operation is detected on the headset is a second moment;
duration between the first moment and the second moment is a first duration; and
a sum of the first duration and duration of action force of the second push operation is less than or equal to a second preset duration.

14. The method according to claim 13, further comprising:
detecting absence of a third push operation on the headset within the second preset duration after the volume level of the headset is adjusted to the second volume level, and closing the volume adjustment function; or
detecting a third push operation based upon continuous application of action force to the headset within the second preset duration after the volume level of the headset is adjusted to the second volume level, and closing the volume adjustment function.

15. The method according to claim 11, wherein duration between a moment at which the volume adjustment function is started and a moment at which the volume adjustment function is closed is less than or equal to a first threshold; or
a quantity of times of adjusting the volume level of the headset is less than or equal to a second threshold.

16. A headset, comprising:
a processor, a memory, and one or more programs, wherein
the one or more programs are stored in the memory and comprise instructions that, when executed by the processor, enable the headset to:
detect receipt of a first push operation of applying action force to the headset in a first direction or a second direction, and starting a volume adjustment function, wherein the first direction corresponding to a volume increase function, and the second direction corresponds to a volume decrease function; and
detect that duration of the action force of the first push operation is greater than or equal to first preset duration, and adjusting a volume level of the headset in accordance with the duration of the first push operation.

17. The handset according to claim 16, wherein the adjusting the volume level of the headset comprises:
adjusting the volume level of the headset to a first volume level at a first moment; and
adjusting the volume level of the headset to a second volume level at a second moment, wherein the second moment is later than the first moment.

18. The handset according to claim 17, wherein duration between the first moment and a moment at which the volume adjustment function is started is equal to second preset duration, and duration between the second moment and the first moment is equal to third preset duration.

19. The handset according to claim 17, wherein the method further comprises:
detecting cancelation of the first push operation on the headset, and closing the volume adjustment function.

20. The handset according to claim 16, wherein the adjusting the volume level of the headset comprises:
detecting a second push operation on the headset, and adjusting the volume level of the headset to a third volume level in accordance with the second push operation; and
detecting a third push operation on the headset, and adjusting the volume level of the headset to a fourth volume level in accordance with the third push operation.
